(19) United States
(12) Patent Application Publication
(10) Pub. No.: US 2016/0238186 A1
(43) Pub. Date: Aug. 18, 2016

(54) INSULATION STRUCTURE COMPRISING INSULATION UNITS AND MANUFACTURING METHOD THEREFOR

(71) Applicant: Woonam KIM, Seoul (KR)

(72) Inventors: Changsub SHIM, Seoul (KR); Sangkwon SHIM, Seoul (KR)

(73) Assignee: Woonam KIM, Seoul (KR)

(21) Appl. No.: 15/061,689

(22) PCT Filed: Sep. 4, 2014
(86) PCT No.: PCT/KR2014/008338

§ 371 Date: Mar. 4, 2016

(30) Foreign Application Priority Data
Sep. 5, 2013 (KR) 10-2013-0106423
Sep. 12, 2013 (KR) 10-2013-0109824
Sep. 30, 2013 (KR) 10-2013-0116409
Oct. 28, 2013 (KR) 10-2013-0128646
Oct. 28, 2013 (KR) 10-2013-0128652
Oct. 28, 2013 (KR) 10-2013-0128659
Dec. 17, 2013 (KR) 10-2013-0157286

(51) Int. Cl. F16L 59/02; B23P 19/04; F16L 59/08

(52) U.S. Cl. CPC F16L 59/02; F16L 59/08; B23P 19/04

(57) ABSTRACT

An insulation structure having insulation units a coating membrane including a plurality of insulation units including a heat reflective film to be coated on the entire inner circumference of the space a space therein providing an insulation structure applicable to various fields and improving the insulation properties thereof.

### TECHNICAL FIELD

The present invention is related to providing an insulation structure comprising insulation units and a manufacturing method there for, and particularly, to providing an insulation structure applying to various fields and improving the insulation property and manufacturing method there for.

### BACKGROUND ART

In a construction field, etc. there has been made various studies in order to increase the insulation efficiency. For one example, as shown in FIG. 1, Korean Patent Laid-Open Publication No. 2011-82099 discloses that a heat reflective multi-story panel 100 comprises a pair of heat reflective plates 20 and 20a disposing heat reflective materials 23 to face each other on one sides of each of surface materials 21 and 21a and a spacer 30 inserted between the heat reflective plates 20 and 20a to form an air layer.

Also, as shown in FIG. 2, Korean Patent Laid-Open Publications No. 2013-19786 discloses that an insulation structure comprises a first insulation panel 110 and a second insulation panel 120 each including a first radiant heat reflective sheet 141 and a second radiant heat reflective sheet 142 disposed on each one side thereof to face each other and an intermediate panel 130 each forming grooves 131 and 132 in a certain pattern between the radiant heat reflective sheets 141 and 142.

As described above, the general insulation structures have disadvantages in that since the heat reflective plate and the radiant heat reflective sheet are easily exposed to a pollution source due to the open air, the heat reflective efficiency is decreased as time passes after installation. Due to it, the insulation durability drops. Also, it has structural defects in that due to a larger volume and greater size, the insulation structure is difficult to handle, used only for the building insulation and has limitations to the use compatible with home appliances and industrial plants such as special clothes, automobiles, refrigerators, etc. that need the insulation or keeping warmth except for the building insulation.

### Technology Problem

In consideration of these and those problems, an object of the present invention is to provide an insulation structure comprising a plurality of insulation units of a sphere or hemisphere type, on at least the inner circumference of which a heat reflective film is coated.

Other object of the present invention is to provide an insulation structure comprising an insulation unit of a sphere or hemisphere, on an inner circumferential surface of which a heat reflective film is coated to reflect heat rays in a scattered manner in a space portion thereof, thereby catching and capturing the heat rays in the space, efficiently.

Another object of the present invention is to provide an insulation structure enabling the compatible use in various fields such as home appliances, industrial plants, constructions, etc. covering clothes, automobiles or vehicles, refrigerators, etc. and the simple adaptation and installation.

Another object of the present invention is to provide an insulation structure comprising a plurality of insulation units of a sphere or hemisphere type including a heat reflective film formed on the inner circumference thereof with being closed to basically prevent the contact with a pollutant, thereby preventing the degradation of the heat reflection and insulation efficiency for a long time.

Another object of the present invention is to provide an insulation structure comprising insulation units of a sphere or hemisphere type unintentionally stacked in multi-stories within a predetermined thickness region, so that an area of a heat reflective film is significantly increased compared with a conventional configuration of a sheet type.

Another object of the present invention is to provide an insulation structure comprising insulation units of a sphere or hemisphere type unintentionally filled up within a predetermined thickness region, so that spaces between the insulation units of a sphere or hemisphere type function as a ventilation passage of the open air, thereby removing the requirement of a separate ventilator.

Another object of the present invention is to provide an insulation structure comprising an insulation unit of a sphere type, on the outer circumference of which a heat reflective film is coated, and a mold provided with a space to fill up a plurality of insulation units therein.

Another object of the present invention is to provide an insulation structure for maximizing an area of a heat reflective film with insulation units of a sphere type being unintentionally filled in a mold including spaces and making the spaces between the insulation units served as the open air passage by itself, so that it is not necessary to install a separate ventilator, even though the open air passage is not provided in the mold.

Another object of the present invention is to provide an insulation structure comprising spaces rugged formed there between to function as the open air passage by itself.

Another object of the present invention is to provide a manufacturing method of an insulation structure comprising steps of forming a closed space of a hemisphere type on a basic material of a flat plate shape, coating a heat reflective film on the inner circumference of the closed space of a hemisphere type and then joining a transparent sheet to one side of a basic material to isolate the closed space of a hemisphere type from the open air, thereby facilitating the manufacturing thereof and improving the insulation effect.

Another embodiment of the present invention is to provide an insulation structure comprising insulation units coating a heat reflective film in a closed space of a hemisphere type, so that heat rays incident into the closed space of a hemisphere type are induced to make a scattered-reflection in parts, limitedly, and some heat rays are captured in the closed space of a hemisphere type, and the other heat rays are effectively discharged toward the incident portion thereof, thereby improving the insulation and warmth keeping effects, significantly.

Another embodiment of the present invention is to provide an insulation structure comprising a plurality of insulation units forming a partial reflective film of a hemisphere, pyramid or conical type in the inner space thereof, wherein a plurality of the insulation units are configured so that the partial heat reflective films are regularly arranged, thereby improving the insulation effect.

Another object of the present invention is to provide an insulation structure comprising a plurality of insulation units of a hemisphere, pyramid or conical type, on a part of the inner circumference of which a heat reflective film is coated in any one of a sphere, hemisphere, pyramid or conical form in parts, so that heat rays incident into the insulation units are induced to limitedly do the scatter-reflection toward one direction in the closed space to capture a part of heat rays in the closed space of the insulation unit and discharge the other heat rays toward the incident one, effectively, thereby improving the insulation and warmth keeping effects, significantly.

### Technology Solution

According to a first embodiment of the present invention, an insulation structure comprises a coating membrane including a space therein and a plurality of insulation units including a heat reflective film to be coated on the entire inner circumference of the space. The insulation includes an integral independent entity, and the insulation unit is configured as a sphere or hemisphere type, on the outer circumference of which the heat reflective film is additionally coated.

The space of the insulating units is closed, into which an argon gas having the heat transmission coefficiency lower than that of air is injected. The heat reflective film is made of aluminum. The insulation unit is attached to a support member. The support member is made of any one of Vinyl sheets, Nonwoven fabrics, Synthetic fibers and Natural fibers. The insulation unit is filled up in a space of a predetermined size. The insulation structure has a diameter of 2 to 30 mm.

According to a second embodiment of the present invention, an insulation structure comprises an insulation unit including a sphere filling the inner part thereof, an insulation unit coating a heat reflective film on the outer circumference of the sphere and a mold including a space, in the inner portion of which a plurality of insulation units are filled up. The sphere is made of a foaming resin such as Styrofoam, etc. and the heat reflective film is made of aluminum. The mold includes the space made of at least one to be selected among Panels, Vinyl sheets, Non-woven fabrics, Synthetic fibers and Natural fibers. The insulation unit has a diameter of 10 to 100 mm.

According to a third embodiment of the present invention, an insulation structure comprises a first sheet including a heat reflective film formed on at least one surface thereof, a second sheet including a plurality of recesses of a hemisphere type in a domed form and a plurality of closed spaces formed by the recesses in a domed form between a surface forming the heat reflective film of the first sheet and the second sheet. The first sheet is made of at least one to be selected among Panels, Vinyl sheets, Non-woven fabrics, Synthetic fibers and Natural fibers. The heat reflective film includes an aluminum or silver foil. The second sheet is made of Synthetic resins or Vinyl. An argon gas having the heat transmission coefficiency lower than that of air is injected into the closed space.

According to a third embodiment of the present invention, a manufacturing method of an insulation structure comprises steps of forming a heat reflective film on at least one surface of a first sheet, forming a plurality of recesses of a hemisphere type in a domed form on the second sheet and forming a plurality of closed spaces by the recesses in a domed form between a surface forming the heat reflective film of the first sheet and the second sheet. In the process of forming the closed space, the method further comprises a step of injecting an argon gas having the heat transmission coefficiency lower than that of air into the closed space.

According to a fourth embodiment of the present invention, an insulation structure comprises insulation units of a rod type arranged adjacent to each other including a closed space formed therein and a heat reflective film formed on an entire surface or a part surface of the closed space. The insulation units of a rod type and the closed space are configured into a cylindrical shape along a length direction thereof. The insulation units of a rod type and the closed space are configured into a semi-cylindrical shape along a length direction thereof. The heat reflective film of a cylindrical shape is formed as a sphere or a hemisphere in the closed space. The heat reflective film of a semi-cylindrical shape is formed as a hemisphere in the closed space. The insulation unit of a rod type is made of a material including any one of Synthetic resins, Vinyl and Styrofoam. The heat reflective film includes an aluminum or silver foil. The second sheet is made of Synthetic resins or Vinyl. An argon gas having the heat transmission coefficiency lower than that of air is injected into the closed space.

According to a fifth embodiment of the present invention, an insulation structure comprises a basic material, a plurality of closed spaces of a hemisphere type formed on at least one side of the basic material, a heat reflective film formed in the closed space of a hemisphere type and a transparent sheet joined to the basic material forming the closed spaces to isolate the closed space from the open air thereon, wherein a thickness of the basic material is at least greater than a radius of the closed space.

According to the fifth embodiment of the present invention, an insulation structure comprises a basic material, a plurality of closed spaces of a hemisphere type formed on at least both sides of the basic material, a heat reflective film formed in the closed space of a hemisphere type and a transparent sheet joined to both sides of the basic material forming the closed spaces to isolate the closed space from open air thereon, wherein the basic material is made of a flame retardant resin and a vinyl resin.

According to a sixth embodiment of the present invention, an insulation structure comprises a coating membrane forming a closed space and a plurality of insulation units including a heat reflective film formed in parts on a curved surface of the inner circumference of the coating membrane to reflect heat rays incident into the closed space toward the outside of the coating membrane. The partial coating membrane includes at least one part that is transparent. The heat reflective film is in the form of any one to be selected among a hemisphere shape, a pyramid shape and a conical shape. The partial heat reflective film is disposed in a direction having a constant rule. The insulation structure further comprises a shell formed on at least one side thereof.

According to the sixth embodiment of the present invention, a manufacturing method of an insulation structure comprises steps of preparing a first sheet in the inner circumference of which a plurality of recesses are formed, forming the heat reflective film inside the recesses, preparing a second sheet on a side opposite to the recesses of the first sheet and joining the first sheet to the second sheet so that the recesses of the first sheet are formed in the closed space. The recess of the first sheet is in the form of any one to be selected among a hemisphere, a pyramid shape and a conical shape.

Also, the first sheet and the second sheet are made of a plastic vinyl, and the partial heat reflective film includes an aluminum film.

### Advantage Effects

In a first embodiment of the present invention, an insulation structure is configured to form a set of insulation units of a sphere or hemisphere on the inner circumference of which a heat reflective film is coated in aluminum, thereby enabling the easy use in various fields requiring for the insulation.

The insulation structure has effects in that since it is difficult to easily radiate heat rays incident into the insulation unit from the outside the heat is effectively shut up or captured, thereby improving the limitation of the heat transmission coefficiency and movement onto both sides by the reference of the insulation structure.

Also, it is not anxious that the heat reflective film is exposed to the pollutant of the open air even under any condition regardless of a fixed mold. It has an effect in that even with lapse of a long time after installation the insulation efficiency does not drop. Further, even though a part of insulation units is damaged, only the insulation effect of corresponding parts drops. The other part is not influenced on the function. Therefore, it improves the work loss due to the replacement of bad parts of the insulation structure in the process of the installation and keeps the insulation quality at a constant level.

In a second embodiment of the present invention, an insulation structure comprises a sphere in the inner portion of which predetermined members are filled up, a plurality of insulation units including a heat reflective film coated on the outer circumference of the sphere and a mold provided with a space for filling up a plurality of insulation units, thereby providing effects of being able to flexibly apply to various fields necessary for the insulation. Also, it has an effect in that an area of the heat reflective film can be maximized to improve the limitations of the heat transmission coefficiency and movement toward both sides by the reference of the insulation structure. Also, it has an effect in that the space between the insulation units serves as a ventilating passage without providing a separate ventilator.

In a third embodiment of the present invention, an insulation structure comprises a first sheet forming a heat reflective film, a second sheet including a plurality of domed recesses and a plurality of closed spaces formed by the domed recesses between a surface forming the heat reflective film in the first sheet and the second sheet, thereby basically preventing the pollution of the heat reflective film and flexibly applying to various fields necessary for the insulation. It has an effect in that an area of the heat reflective film can be maximized to improve the limitations of the heat transmission coefficiency and movement toward both sides by the reference of the insulation structure. Also, it has an effect in that the space between the insulation units serves as a ventilating passage without providing a separate ventilator.

In a fourth embodiment of the present invention, an insulation structure comprises a closed space formed therein and a plurality of insulation units of a rod type forming a heat reflective film on an entire surface or a part of the closed space, wherein the insulation units are arranged adjacent to each another, thereby basically preventing the pollution of the heat reflective film and flexibly applying to various fields necessary for the insulation. It has an effect in that an area of the heat reflective film can be maximized to improve the limitations of the heat transmission coefficiency and movement toward both sides by the reference of the insulation structure.

In a fifth embodiment of the present invention, an insulation structure comprises a basic material, a plurality of a hemisphere type formed on the basic material, a heat reflective film formed in the closed space of a hemisphere type and a transparent sheet joined to the basic material, in the inner portion of which the closed space is formed, to be isolated from the outside, wherein the basic material has a thickness greater than a radius of the closed space of a hemisphere type. Therefore, the heat reflective film formed on the inner circumference of the closed space of a hemisphere type and the transparent sheet isolating the closed space from the outside act to have the excellent properties of the insulation and keeping warmth. It has an effect in that the basic material having a predetermined thickness always supports the shape of the closed space of a hemisphere space in a solid state to secure the stiffness of each of the insulation units.

Also, the heat rays incident into the transparent sheet are introduced to limitedly do the scattered-reflection in the hemisphere coating the heat reflective film, thereby repressing one part the convection movement of the heat, capturing other part in the closed space of a hemisphere type and discharging the other part toward the transparent sheet into which the heat rays were incident. Therefore, it has an effect in that the limitations to the heat transmission coefficiency and movement toward one side by the reference of the insulation unit are much improved. Also, it has effects in that the insulation efficiency doesn't drop even with lapse for a long time after installation, and the insulation function of the insulation of structure is not deteriorated even if a part of a plurality of insulation units is damaged.

In a sixth embodiment of the present invention, the insulation units constituted as a insulation structure includes a partial heat reflective film formed in a sphere, a hemisphere, a pyramid or conical shape on the inner circumference of a coating membrane including a closed space. Therefore, the heat rays incident into the insulation unit coating the heat reflective film in parts are introduced to do the scattered-reflection in the closed space of a sphere, a hemisphere, a pyramid or conical shape, thereby capturing a part of the heat rays and discharging the other heat rays by the partial heat reflective film toward the incident direction of the heat rays. it has an effect in that the limitations to the heat transmission coefficiency and movement toward one side by the reference of the insulation unit are much improved. Also, it has effects in that the insulation efficiency doesn't drop even with lapse for a long time after installation, and the insulation function of the insulation of structure is not deteriorated even if a part of a plurality of insulation units is damaged.

### BRIEF DESCRIPTION OF DRAWINGS

The present invention will be described in detail with reference to the attaching drawings as follows;

FIG. 1 is a drawing showing an example of a heat reflective insulation panel according to a prior art,

FIG. 2 is a drawing showing the other example of a heat reflective insulation panel according to a prior art,

FIG. 3 is a cross-sectional view illustrating one example of an insulation unit according to a first embodiment of the present invention,

FIG. 4 is a cross-sectional view illustrating other example of the insulation unit according to the first embodiment of the present invention,

FIG. 5 is a solid view illustrating the insulation units of different sizes arranged in a set form according to the first embodiment of the present invention,

FIG. 6 is a solid view illustrating the insulation units of the same size arranged in a gathering state according to the first embodiment of the present invention,

FIG. 7 is a cross-sectional view illustrating one example of an insulation structure including the insulation units arranged in a gathering state according to the first embodiment of the present invention,

FIG. 8 is a cross-sectional view illustrating other example of an insulation structure including the insulation units arranged in a gathering state according to the first embodiment of the present invention,

FIG. 9 and FIG. 10 each are cross-sectional views illustrating another embodiment according to the first embodiment of the invention,

FIG. 11 is a cross-sectional view illustrating insulating units according to a second embodiment of the present invention,

FIG. 12 is a solid view illustrating the insulation units of different sizes arranged in a set form according to the second embodiment of the present invention,

FIG. 13 is a solid view illustrating the insulation units of the same size arranged in a set form according to the second embodiment of the present invention,

FIG. 14 is a cross-sectional view illustrating one example of an insulation structure including the insulation units arranged in a gathering state according to the second embodiment of the present invention,

FIG. 15 is a cross-sectional view illustrating other example of an insulation structure including the insulation units arranged in a gathering state according to the second embodiment of the present invention,

FIG. 16 is a cross-sectional view of FIG. 15,

FIG. 17 is a solid view illustrating the other example according to a third embodiment of the present invention,

FIG. 18 is a cross-sectional view of FIG. 17,

FIG. 19 is a solid view illustrating one example according to a fourth embodiment of the present invention,

FIG. 20 is a cross-sectional view of FIG. 19,

FIG. 21 is a solid view illustrating the other example according to the fourth embodiment of the present invention,

FIG. 22 is a cross-sectional view of FIG. 21,

FIG. 23 is a cross-sectional view illustrating a heat reflective mechanism of an insulation unit included in an insulation structure according to a fifth embodiment of the present invention,

FIG. 24 is a solid view illustrating one example of an insulation structure according to the fifth embodiment of the present invention,

FIG. 25 is a cross-sectional view illustrating the insulation structure cut along Line A-A according to the fifth embodiment of the present invention,

FIG. 26 is a solid view illustrating the other example of the insulation structure according to the fifth embodiment of the present invention,

FIG. 27 is a cross-sectional view illustrating the insulation structure cut along Line B-B according to the fifth of the present invention,

FIG. 28 is a cross-sectional view illustrating a modified example according to the fifth embodiment of the present invention,

FIG. 29 is a solid view illustrating one example of an insulation structure according to a sixth embodiment of the present invention,

FIG. 30 is a partial cross-sectional view illustrating the insulation structure cut along Line A-A according to the sixth embodiment of the present invention,

FIG. 31 is a cross-sectional view illustrating one example attaching an outer shell to the insulation structure of FIG. 29,

FIG. 32 is a cross-sectional view illustrating the other example attaching an outer shell to the insulation structure of FIG. 29,

FIG. 33 is a schematic view illustrating a test chamber for testing the insulation unit according to the first embodiment of the present invention,

FIG. 34 is a simulative solid view illustrating the movement of a heat in each of the insulation units of a first example according to the sixth embodiment of the present invention,

FIG. 35 is a graph illustrating the movement of the heat in each of the insulation units according to the first example according to the sixth embodiment of the present invention,

FIG. 36 is a simulative solid view illustrating the movement of the heat in a plurality of the insulation units according to the first embodiment of the present invention,

FIG. 37 is a schematic view illustrating a test chamber for testing the insulation unit according to the sixth embodiment of the present invention,

FIG. 38 is a simulative solid view illustrating the movement of a heat in each of the insulation units according to the sixth embodiment of the present invention,

FIG. 39 is a graph illustrating the movement of the heat in each of the insulation units according to the sixth embodiment of the present invention,

FIG. 40 is a simulative solid view illustrating the movement of the heat in a plurality of the insulation units of the first example according to the sixth embodiment of the present invention,

FIG. 41 is a solid view illustrating the other example of the insulation structure according to the sixth embodiment of the present invention,

FIG. 42 is a partial cross-sectional view illustrating the insulation structure cut along Line B-B of FIG. 41.

FIG. 43 is a partial cross-sectional view illustrating another example according to the sixth embodiment of the present invention,

FIG. 44 is a partial cross-sectional cutting along Line C-C of FIG. 43, and

FIG. 45 is a view illustrating other aspect of the insulation unit according to the sixth embodiment of the present invention.

### DETAILED DESCRIPTION OF THE PREFERRED EMBODIMENTS

### Best Mode for Carrying Out the Invention

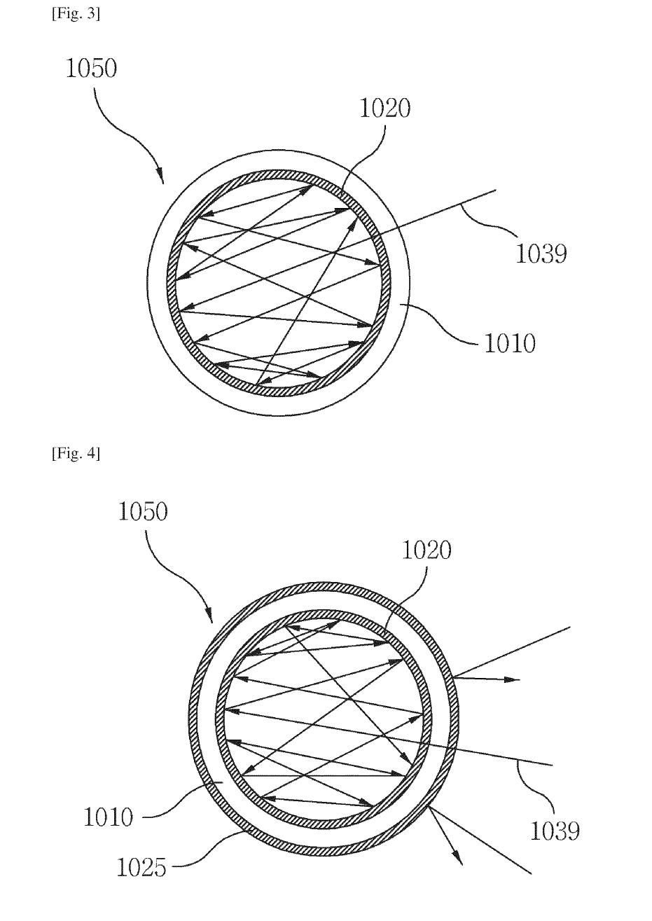

The present invention will be explained in detail in connection with the technical configuration, acting effect and manufacturing method of an insulation structure with reference to the attached drawings of FIG. 3 to FIG. 45, as follows:

### First Embodiment

A first embodiment of the present invention will be now described with reference to FIGS. 3 to 10. According to the first embodiment of the present invention, an insulation structure comprises a set of insulation units of a sphere or hemisphere type, for example a configuration that at least one layers of insulation units of a sphere or hemisphere type are arranged adjacent to each another, in the inner surface of which a heat reflective film is coated.

As shown in FIG. 3, for one example, an insulation unit 1050 comprises coating membranes 1010 each made of the same material and a heat reflective film 1020 coated on the inner circumference of the coating membrane 1010, wherein the heat reflective is an integral independent sphere. It is preferable that the diameter of the insulation unit 1050 is set at 2˜30 mm, but the size is not limited and can be properly changed according to the conditions of use.

The insulating units 1050 of a sphere type is configured in a manner that a heat reflective film 1020 is coated on the inner circumference of the coating membrane 1010 made of Synthetic resins or Vinyl materials. The coating membrane 1010 is made of nonflammable materials or materials mixed with commercial obtained nonflammable ones except for above materials.

The heat reflective film is configured in a manner to coat a material having a higher heat reflective rate, for example an aluminum film by a predetermined thickness and seal the inner space of a sphere type for the entirely isolation from the open air. Additionally, argon gas having a heat transmission coefficiency lower than air is thrown into the inner space of a sphere type to be sealed. The insulation unit 1050 induces incident heat rays 1039 to be unintentionally reflected in the inner space thereof, thereby capturing the incident heat rays therein in case that the heat rays are thrown into and transmitted through the insulation unit from the outside thereof. It is difficult to pass the heat rays 1039 through the insulation unit and to radiate the heat. Therefore, it improves the insulation effect bordering on the insulation units 1050.

Particularly, the inner space of the insulation units is basically prevented from the exposure of polluted air even with lapses of a long time. Therefore, it has an effect in that the heat reflective efficiency in the inner space of a sphere type is not deteriorated for a long time.

As shown in FIG. 4, a heat reflective film 1025 for example Aluminum film, etc. is coated is additionally coated on the outer circumference of the coating membrane 1010 in the insulation units 1050 of a sphere type. If the heat reflective film 1025 is formed on the outer circumference of the coating membrane 1010, a part of the heat rays 1039 is reflected on the outside heat reflective film 1025. The other heat rays 1039 transmitted into the insulation unit are unintentionally reflected and captured in the inner space of the insulation units, thereby increasing the insulation effect double

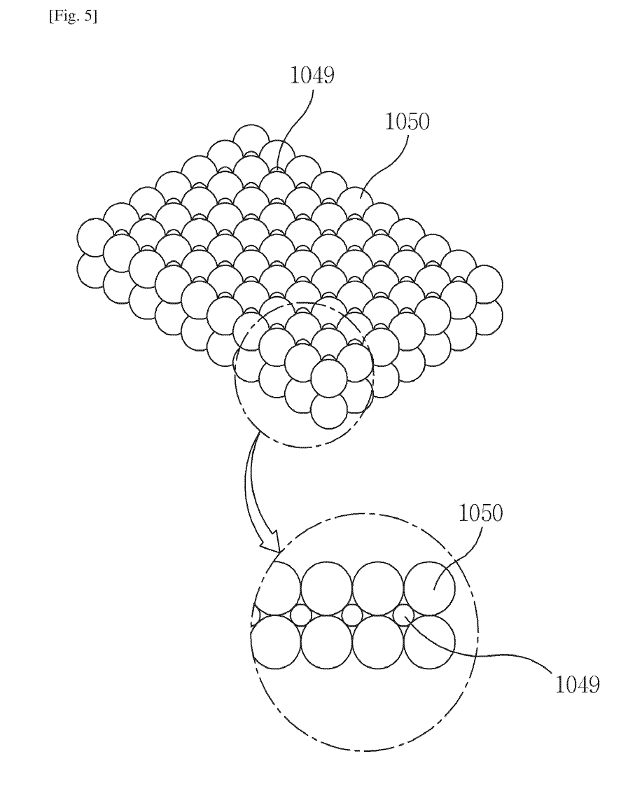

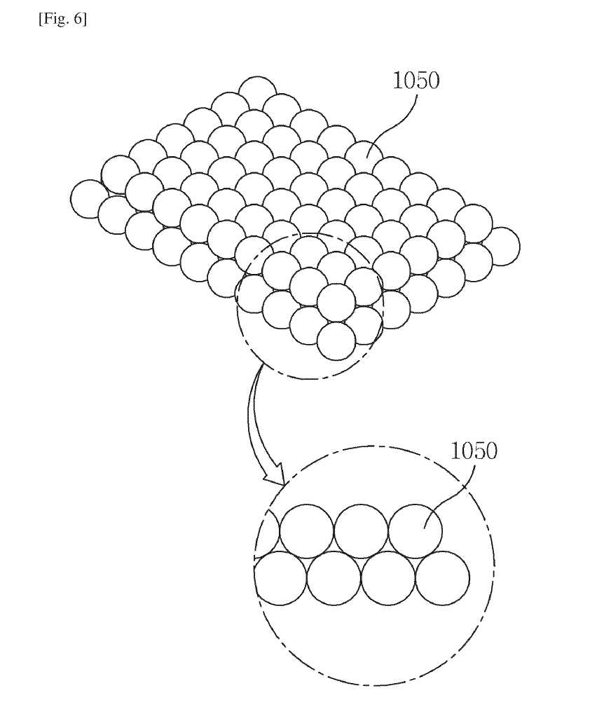

Also, as shown in FIG. 5, if insulation units 1050 include independent spheres, the insulation units 1050 are arranged in two stories, and insulation units 1049 of a relative smaller size are disposed in spaces between the insulation units 1050. As shown in FIG. 6, the insulating units 1050 of the same size may be disposed in more than two layers.

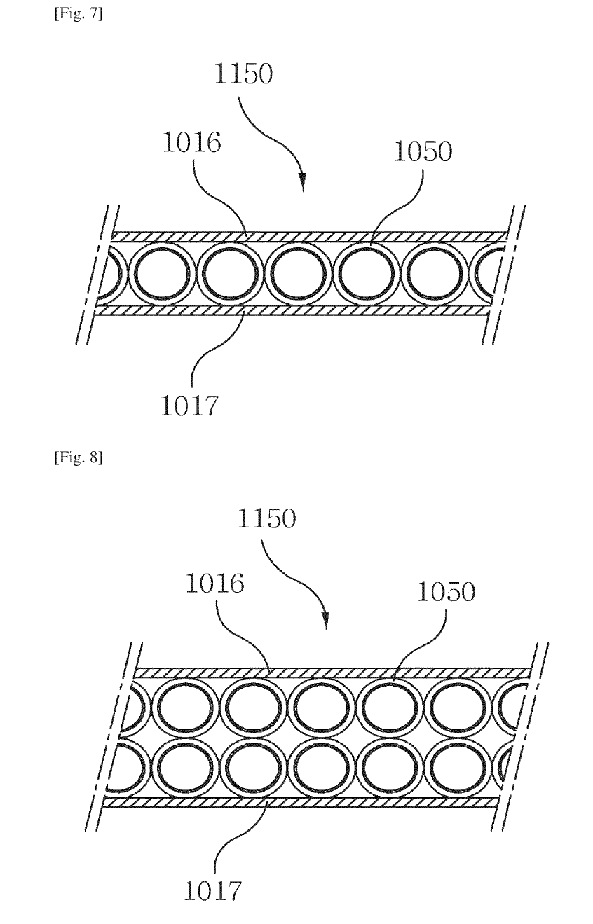

As shown in FIG. 7, insulation units 1050 are arranged in a single story and wrapped in outer shells 1016 and 1017 for the support thereof. In other manner, as shown in FIG. 8, the insulation units are arranged in multiple stories, namely two stories in the drawing and wrapped in the outer shells 1016 and 1017 for the support thereof.

In FIG. 7, the outer shells 1016 and 1017 support the insulation units 1050 on only either side thereof. The insulation units 1050 are adhered by an adhesive to at least one side of the outer shell. The outer shells 1016 and 1017 enable the use of a plate material such as Styrofoam or the like, Wooden boards, Vinyl sheets, Nonwoven fabrics, Woven synthetic fibers, Cloths made of natural fibers.

As described above, regardless of a material of the outer shells 1016 and 1017, the easy use of the insulation unit 1050 is possible because the insulation unit includes an independent sphere of a small size or a sheet form freely bent or folded.

If the outer shells 1016 and 1017 are made of a soft plate material of Styrofoam etc. or a hard plate material of Wooden boards, etc., the insulation units 1050 are filled up in spaces between them. The spaces between the insulation units 1050 has an advantage of serving as a ventilation passage with the open air without forming separate air passages in contact with the open air between the hard plates, thereby improving the efficiency of the installation work, significantly. Furthermore, the insulation units of a sphere or hemisphere type are randomly stacked in a predetermined space to greatly increase a total area of summing each of the heat reflective films thereof comparing with the configuration of a conventional plate sheet

If the outer shells 1016 and 1017 are made of Vinyl sheets, Nonwoven fabrics, Woven synthetic fibers, Cloths such as Natural fibers, etc., they can be freely bent or folded to allow the use thereof in a wall space of vehicles or spaces of winter clothes and curved wall spaces, etc., so that the installation is simple as well as an additional effect functioning as a cushion upon the collision in case of the use of vehicles, etc. is obtained.

Also, even though the insulation units 1049 and 1050 are damaged in parts, the other most insulation units are not taken any influence on the function, so that there is not extended any effect over the insulation quality without separate repairs.

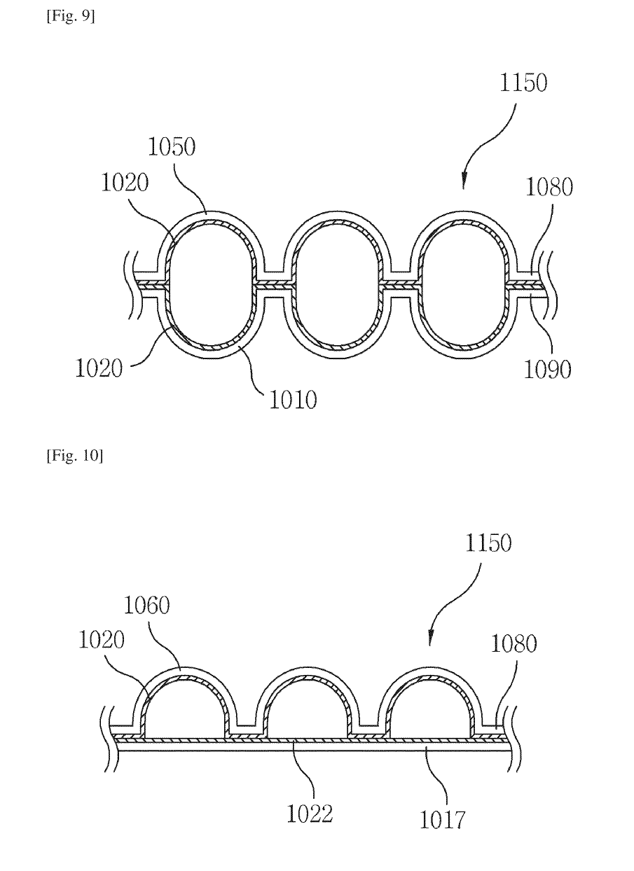

According to the present invention, an insulation structure 1150 comprising insulation units 1050 disposed in a gathering state is not limited to a configuration as described above. For example, as shown in FIG. 9, an insulation structure 1150 comprises a plurality of insulation units 1050 including an upper sheet 1080 forming a plurality of hemispheres and a plurality of lower sheets 1090 formed to be symmetrical to the upper sheets 1080, wherein the upper sheets 1080 are laid over the lower sheets 1090 to be coupled to each other. Of course, before the coupling of the upper sheet 1080 and the lower sheet 1090, an aluminum film is previously coated on the opposite surfaces of the upper and lower sheets 1080 and 1090 of hemisphere type to form a heat reflective film 1020. The upper and lower sheets may be made of a plastic material, a vinyl, a metal, etc.

Also, as shown in FIG. 10, an insulation structure 1150 comprises a plurality of insulation units 1060 of a hemisphere type coating an aluminum film on the surface of an outer shell 1017 to form a heat reflective film 1022 and attaching a plurality of upper sheets 1080 of a hemisphere type onto the reflective film 1022. Before joining the upper sheet 1080 to an outer shell 1017, the heat reflective film 1020 is previously formed in a manner to coat an aluminum film on the hemisphere surface of the upper or lower sheet.

In the configurations of FIGS. 9 and 10, on the outer surface of the upper and lower sheets or the outer surface of the outer shell 1017 an aluminum film, etc. may be additionally coated to form another heat reflective film.

### Second Embodiment

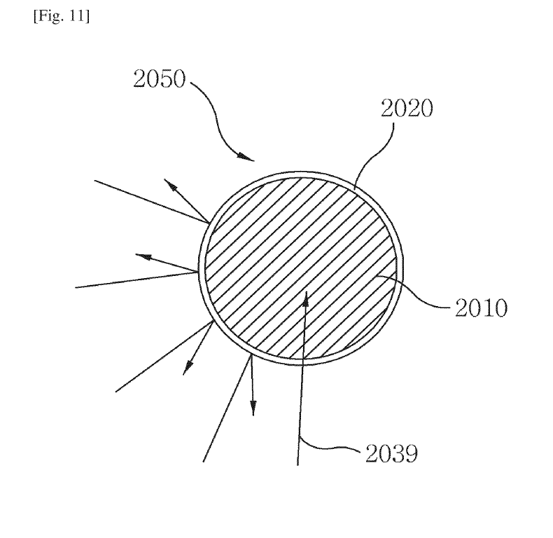

A second embodiment will be described in detail with reference to FIGS. 11 to 14, as follows:

According to the second embodiment of the present invention, an insulation structure comprises insulation units of a sphere type in a gathering state, wherein the insulation units of a sphere type are regularly or unintentionally arranged in at least one story adjacent to each other and heat reflective films are coated on the outer circumference of each of the insulation units.

Giving an example, as shown in FIG. 11, an insulation unit 2050 comprises a sphere 2010 with a predetermined member being filled up therein and a heat reflective film 2020 coated on the outer surface of the sphere to form an integral independent sphere. It is preferable that the insulation units 2050 has a diameter of 10 to 100 mm, but its size is not limited thereto and may be properly changed and used according to the conditions of use.

The heat reflective film is formed in a manner to coat a material of a higher flexibility, for example an aluminum film by a predetermined thickness on an insulation unit. The insulation unit 2050 is configured so that if heat rays 2039 are incident toward the insulation units from the outside, incident heat rays are mostly reflected and only a part thereof is transmitted into the sphere of the insulation unit. Therefore, the heat rays 2039 makes it difficult to pass through the insulation unit and radiate the heat thereof. If the insulation units 2050 are arranged in a plurality of gathering groups, it improves the insulation effect bordering on the insulation units.

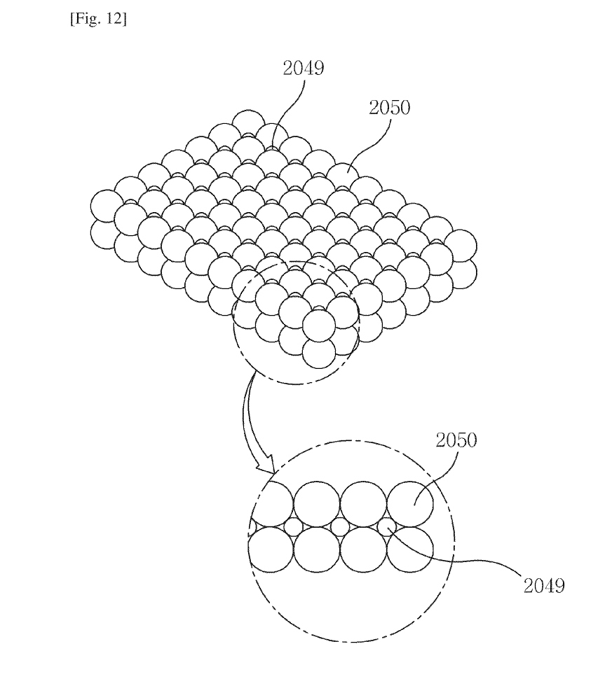

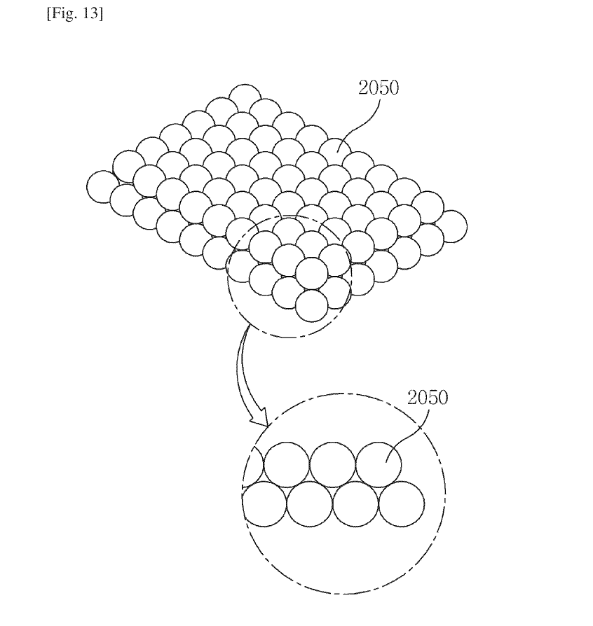

Furthermore, as shown in FIG. 12, insulation units 2050 are constructed in a multilayered arrangement to dispose relative smaller insulation units 2048 in spaces between the insulation units 2050. Otherwise, as shown in FIG. 13, insulation units 2050 are configured in a multilayered arrangement in a manner to lay the insulation units of the same size one upon another.

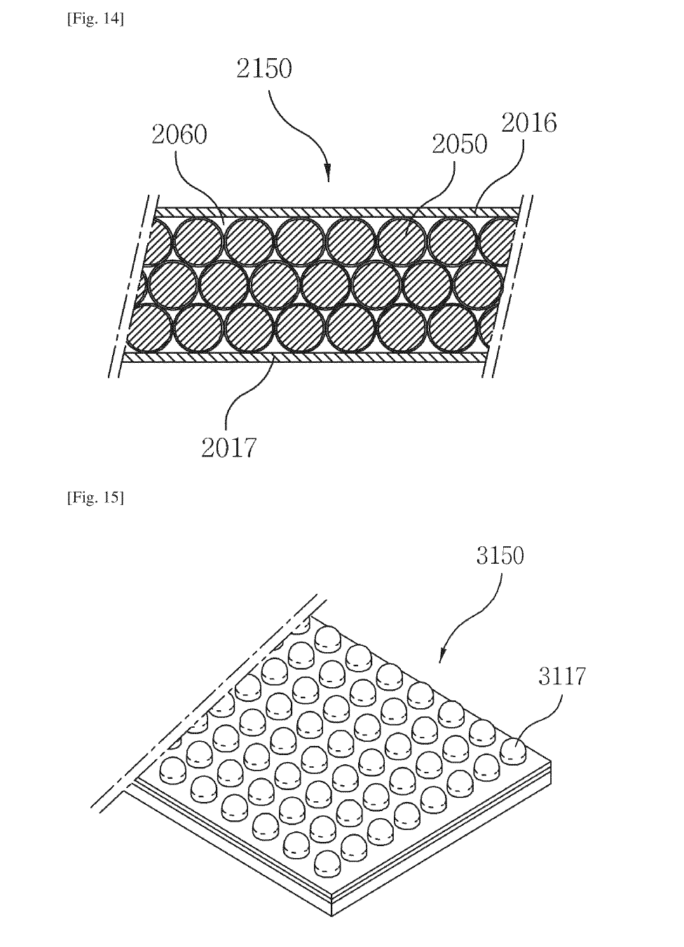

As shown in FIG. 14, the insulation units 2050 are regularly or unintentionally filled up in a space 2060 of a mold constituted as outer shells 2016 and 2017 to form an insulation structure 2150.

The mold constituted as the outer shells 2016 and 2017 may use any one of Plate materials such as Styrofoam, etc., Wooden boards, Vinyl sheets, Nonwoven fabrics, Woven synthetic fibers, Cloths made of natural fibers, Gauzes, etc. Namely, it is enough if the mold has a space for holding the insulation units 2050 therein.

As described above, the mold is not influenced on a material to be constructed. The reason is why the insulation units 2050 are constructed as an independent sphere of a relative smaller size to be able to use a sheet that is freely bendable or foldable.

If the outer shell 2016 and 2017 are made of plate materials of Styrofoam, etc. and hard plate materials of wooden boards, etc., the insulation units are filled up in the space formed by the outer shells. It has an advantage in that spaces between the insulation units 2050 of a sphere type function as a ventilation passage with the open air, thereby improving the installation work efficiency of the insulation structure, significantly.

If the outer shells 2016 and 2017 are made of Vinyl sheets, Nonwoven fabrics, Woven synthetic fibers, Cloths made of natural fibers, Gauzes, etc., the insulation structure is freely bendable or foldable to enable the compatible use in a curved wall space, etc., thereby simplifying the installation work. Even though a part of the insulation units 2049 and 2050 is damaged, the other mostly insulation units don't extend any effect over the function of the insulation structure and the insulation quality without separate repairs.

According to the second embodiment of the present invention, the insulation structure 2150 comprising the insulation units 2050 in a gathering state is not limited to a configuration as described above and can be constructed as various configurations such as Ellipsoid, Polyhedron, etc.

### Third Embodiment

A third embodiment of the present of the invention will be described in detail with reference to FIGS. 15 to 18, as follows.

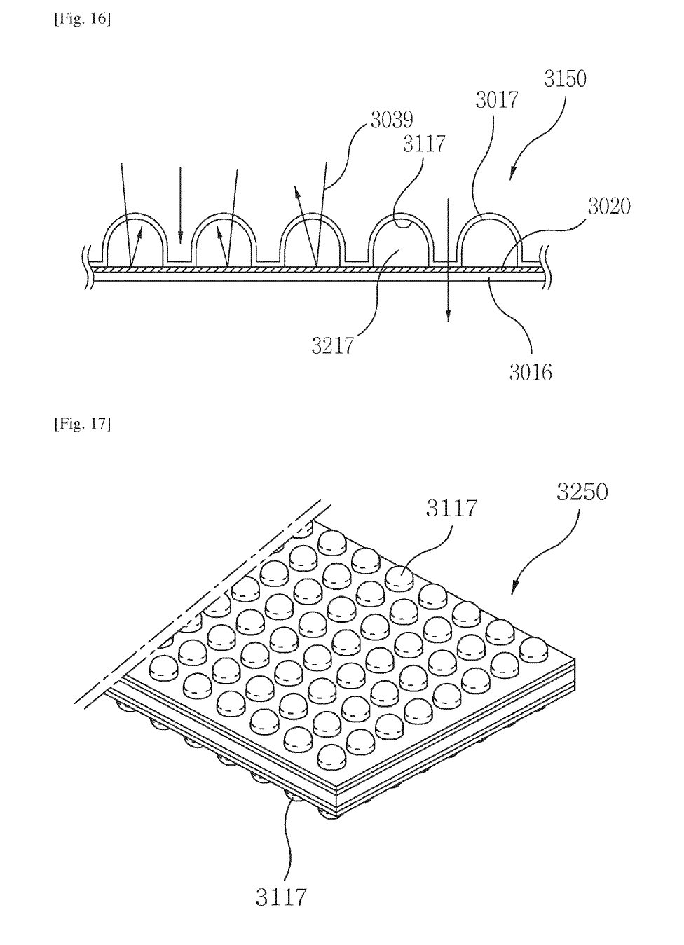

As shown in FIGS. 15 and 16, an insulation structure 3150 comprises a first sheet 3016, a second sheet 3017 and a heat reflective film 3020 formed on one side of the first sheet 3016. The second sheet 2017 includes a plurality of a domed recesses 3117 arranged in the same direction. The recesses 3117 are preferably constructed as a configuration of a hemisphere type or a sphere type having a diameter of 10 to 100 mm, but not limited to the size and shape. The recess may be variously changed and used according to the conditions of use.

The second sheet 3017 is attached to a surface forming a heat reflective film 3020 of the first sheet, so that each of the recesses 3117 forms a closed space 3217. An argon gas having a heat transmission coefficiency lower than that of air may be injected into the closed space.

It is desirable that the first sheet 3016 is flexible and makes it easy to adhere thereto or coat thereon the heat reflective film 3020. If the heat reflective film 3020 such as a silver foil, etc. is used, the first sheet 3016 may be made of non-woven fibers, synthetic fibers, natural fibers, gauzes or the like for the use thereof. If the heat reflective film 3020 is formed in a manner to coat a metal such as an aluminum, etc., a thin metal or non-metal panel, a synthetic resin, a vinyl, etc. that are advantageous to the coating may be used in forming the first sheet.

On the other hand, the second sheet 3017 is made of a transparent material for the light transmission, etc., but not limited to the transparent material. The second sheet 3017 includes a synthetic resin sheet, a vinyl sheet or the like for the conveniences of its handling and manufacturing. The fireproofing and flame-retardant processes may be added to the first sheet 3016 and the second sheet 3017.

As described above, if the heat rays 3039 are incident into the closed space 3217 from the outside of the second sheet 3117, the insulation structure 3150 retards the heat radiation due to it that a part of the hot rays is reflected and the other is captured in the closed space into which the argon gas is injected. Therefore, it improves effects to retard the heat movement and isolate the heat from the outside bordering on the insulation structure 3150.

Also, according to the third embodiment of the present invention, since the insulation structure 3150 is constructed in the form of a freely bendable or foldable sheet, it is properly usable in a curved wall space, etc., and the installation work is simple. Also, it has an advantage in that the uneven spaces in the insulation structure function as a ventilating passage with the open air without forming a separate air one contacting with the open air between the insulation structures, thereby improving the efficiency of the installation work of the insulation structure, significantly.

Furthermore, even though the closed spaces of the insulation structure 3217 are damaged in parts (severally), the insulation structure has advantages in that the other most closed spaces are kept in a closed state and not anxious about the exposure to the open air as well as the function of the heat reflective film is not deteriorated even with the lapse of long time due to it that the heat reflective film is basically isolated from the pollutant source.

According to the third embodiment of the present invention, the insulation structure is not limited to the configuration of FIGS. 15 and 16. As shown in FIGS. 17 and 18 the insulation structure 3250 comprise a first sheet 3016 and a second sheet 3017 attached to be faced to each other on the opposite sides of the first sheet 3016. In other words, the heat reflective films 3020 are formed on the opposite sides of the first sheet 3016, and the second sheets 3017 are joined to each of the opposite sides of the first sheet 3016, so that the insulation structure 3250 is formed to have the closed spaces 3217 bordering on the heat reflective films.

FIGS. 17 and 18 illustrate a configuration of attaching the second sheets 3017 to be faced to each other to the opposite sides of the first sheet 3016, but the present invention is not limited to the configuration. For example, the second sheets 3017 may be attached in a staggered arrangement to the opposite sides of the first sheet.

Thereafter, according to the third embodiment of the present invention, a manufacturing method of the insulation structures 3150 and 3250 will be explained as follows;

First, a heat reflective film 3020 is formed on one side or opposite sides of a first sheet 3016. The heat reflective film 3020 is constructed in a manner to directly coat a metal film of aluminum on the first sheet or attach a silver foil to the first sheet using an adhesive.

Subsequently, the recesses 3217 of a domed shape are formed on the second sheets 3017, and then the second sheets 3017 are attached by an adhesive to the heat reflective films 3020 to form a plurality of closed spaces 3217 by a domed recess between a surface forming the heat reflective film 3020 and the second sheet 3017. In the process of forming the closed spaces 3017 there is performed an additional procedure of injecting an argon gas having heat transmission coefficiency lower than that of air into the closed space 3217. The argon gas acts to retard the heat movement over the air.

### Fourth Embodiment

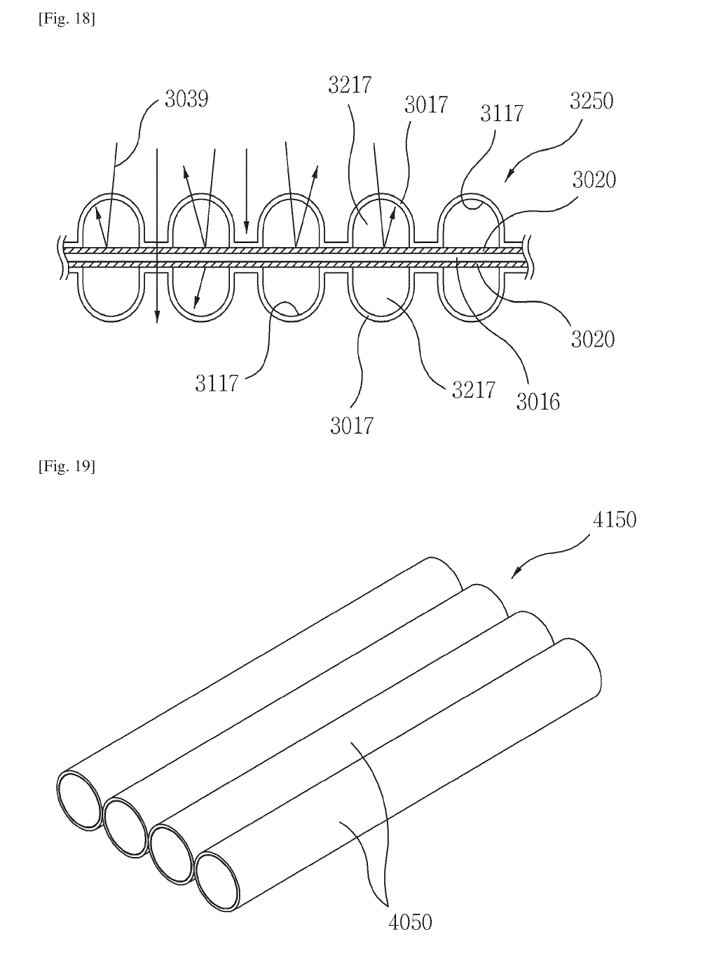

A fourth embodiment of the present invention will be described with reference to FIGS. 19 to 22 as follows;

As shown in FIGS. 19 and 20, according to the fourth embodiment of the present invention, an insulation structure 4150 comprises insulating units 4050 of a rod type to be cylindrical. Each of the insulating units 4050 of a rod type includes a coating membrane 4010 made of Synthetic resins, Vinyl, Styrofoam, etc., an integral closed space formed in the coating membrane along the length direction of the insulation units 4150 and a heat reflective formed in the closed space.

As shown in FIG. 20 (a), the heat reflective film 4025 is formed in a manner to coat aluminum or use a silver foil, etc. on the entire inner circumference of the closed space 4017 that is isolated by the coating membrane 4010. As shown in FIG. 20(b), a heat reflective film 4125 may be configured in the form of a hemisphere type, for example a domed shape. If the heat reflective film 4125 is formed in a hemisphere type, it is disposed along a constant direction.

It is desirable to construct the closed space having a diameter of less than 10 to 100 mm, but not limited to the size and shape. According to the conditions of use, the closed spaces may be variously changed. The argon gas having the heat transmission coefficiency lower than that of air may be injected into the closed space 4017. The closed space 4017 is sealed at the opposite ends of the insulation unit 4050 to be isolated from the open air. The coating membrane 4010 may be additionally processed with fireproofing and flame retarding procedures.

If the heat rays 4039 are incident into the closed space 4017 from the outside, in the configuration of FIG. 20(a) the insulating structure 4150 as described above allows the heat rays 4039 to do the scattered-reflection on the heat reflective film 4025, so that the mostly heat rays are captured and retarded. In the configuration of FIG. 20(b), the mostly heat rays 4039 are reflected only in one direction by the partial heat reflective film 4125, and a part thereof is captured in the closed space 4217 into which the argon gas is injected, thereby retarding the heat radiation. Therefore, it improves the effects of retarding the heat movement and isolating the heat bordering on the insulation structure 4150.

Also, according to the fourth embodiment of the present invention, the insulation structure 4150 is bendable or foldable in one direction, thereby enabling the compatible use in the space of a curved wall and simple installation work thereof. It has advantages in that the spaces between the insulation structures function as an air ventilation passage to the open air without forming a separate ventilator in contact with the insulation structure, thereby improving the efficiency of the installation work of the insulation structure, significantly.

Furthermore, even though the closed spaces 4017 of the insulation structure are damaged in parts, the other mostly closed spaces are kept in a closed state. Therefore, it has advantages in that the insulation structure is not anxious about the exposure to the open air, and the function of the heat reflective films 4025 and 4125 is not deteriorated even with the lapse of long time due to it that the heat reflective film is basically isolated from the pollutant source.

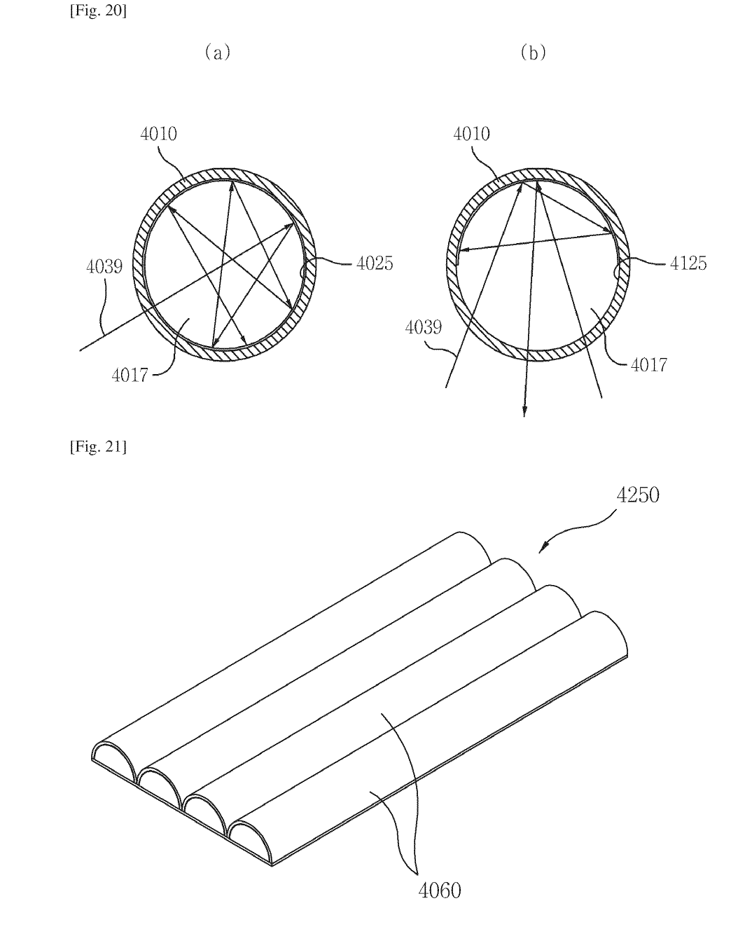

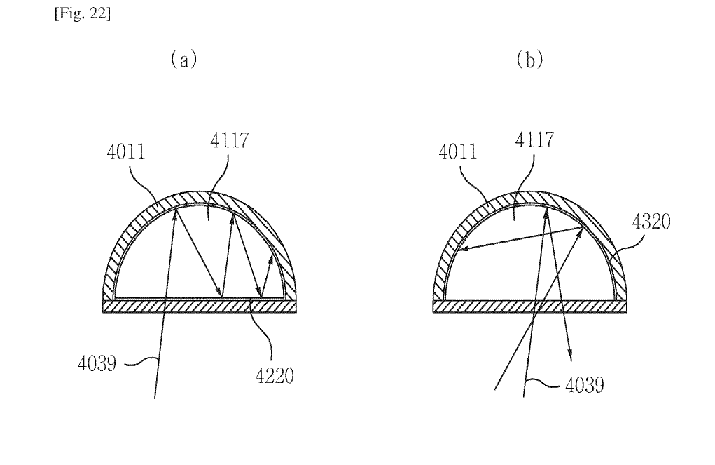

According to the fourth embodiment of the present invention, the insulation structure is not limited to the configuration of FIGS. 19 and 20. As shown in FIGS. 21 and 22 an insulation structure comprises insulation units 4060 of a rod type in a domed shape.

As shown in FIG. 22, an insulation structure 4150 comprises insulation units 4060 of a rod type including a coating membrane 4010 made of Synthetic resins, Vinyl, Styrofoam, etc., an integral closed space 4117 formed in the coating membrane along the length direction of the insulation units and a heat reflective formed in the closed space.

As shown in FIG. 22 (a), a heat reflective film 4220 is formed in a manner to coat aluminum or use a silver foil, etc., on the entire inner circumference of the closed space 4117 that is isolated by the coating membrane 4220. As shown in FIG. 22(b), a heat reflective film 4320 may be made in the form of a hemisphere, for example a domed shape.

An argon gas may be injected into the closed space 4117. The closed space 4117 is sealed at the opposite sides of the insulation structure 4060 to be isolated from the open air. The argon gas acts to retard the heat movement over air.

### Fifth Embodiment

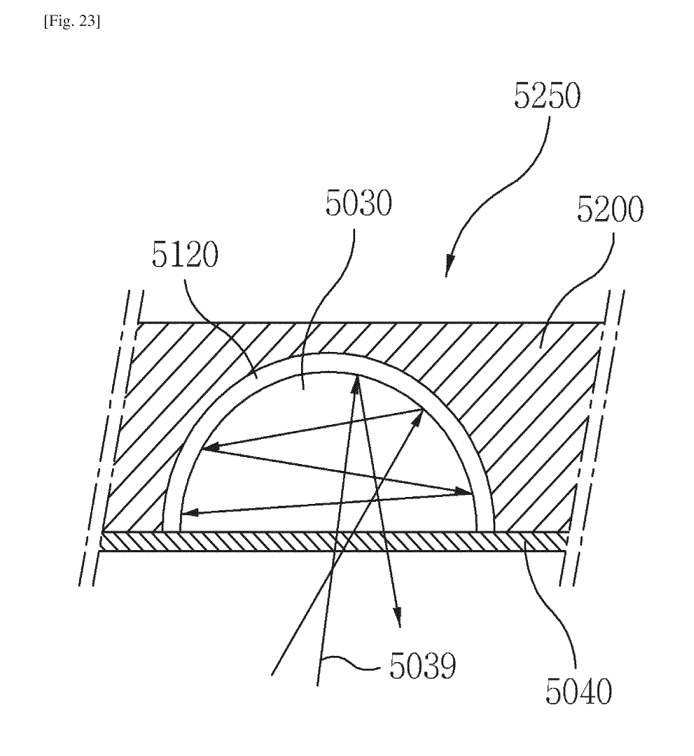

A fifth embodiment of the present invention will be described with reference to FIGS. 23 to 28 as follows.

According to the fifth embodiment of the present invention, as shown in FIG. 23 an insulation structure comprises a basic material 5200 having a predetermined thickness and a plurality of insulation units 5250 including a closed space 5030 of a hemisphere type formed in the basic material, a heat reflective film 5120 coating on the inner circumferential surface of the closed space 5030 of a hemisphere type and a transparent sheet 5040 sealing the closed space 5030. The closed space 5030 is made in a sphere or a domed shape of a pillar type.

The basic material 5200 has at least a thickness larger than a semi-diameter of the closed space 5030 of a hemisphere type and comprises a flat board structure when a transparent sheet 5040 is attached on the outer side thereof.

The basic material 5200 may be made of Synthetic resins, Rubber materials, Vinyl resins, Styrofoam, etc. which have a property of the flame retardant. The transparent sheet 5040 may be made of Synthetic resins or Vinyl resins, etc.

The basic material 5200 is not limited to the materials as described above and may be made of various materials including Glasses, Woods, Plaster, Stones, etc. The heat reflective film 5120 is configured to coat or deposit a thin aluminum film. Particularly, the invention is constructed so that the thickness of the basic material 5200 is over the semi-diameter of the closed space, thereby preventing the variation of the closed space 5030.

As described above, if heat rays 5039 are incident into the insulation structure 5250 through the transparent sheet 5040, the heat rays 5039 incident into the insulation unit by the heat reflective film 5120 coated on the inner circumference of the closed space 5030 are introduced to restrictively do the scattered-reflection toward one direction in the inner portion of the closed space, so that a part of heat rays is kept in a captured state in the closed space and the other heat rays are reflected and emitted toward the incident portion, for example the transparent sheet 5040 with the heat reflective film being not formed.

As described above, the insulation structure is configured so that the heat rays 5039 are restrictively reflected in a scattered manner in parts therein, and the other heat rays are emitted toward the incident portion. Comparing with a configuration of sealing the entire surface with the heat reflective film, the insulation structure rather raises the insulation property thanks to the limitation of the heat convection by the scattered-reflection of the heat rays. The improvement effect of the insulation property will be known in a comparison example described in a sixth embodiment of the present invention.

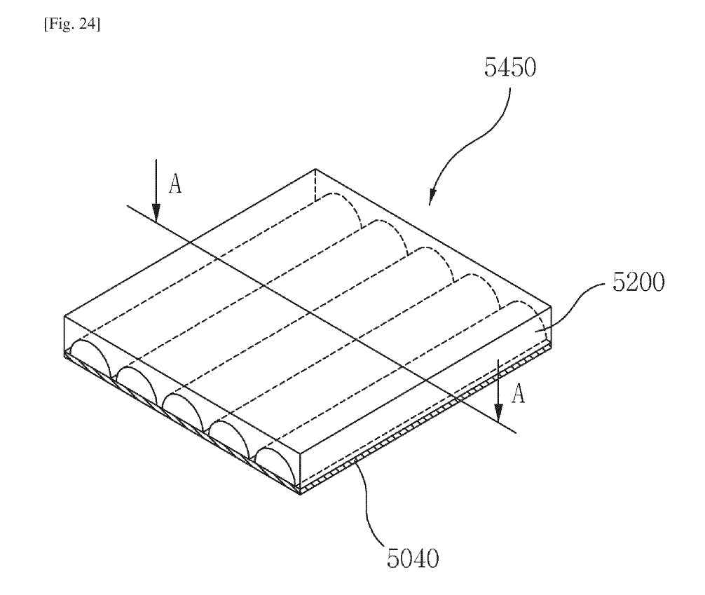

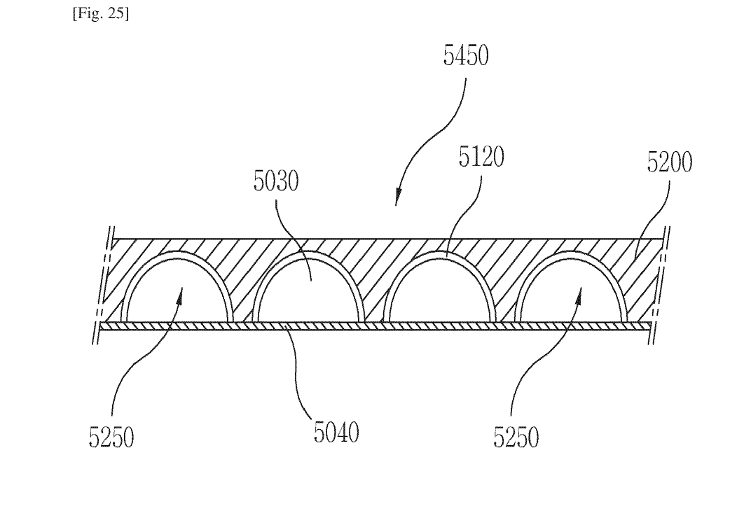

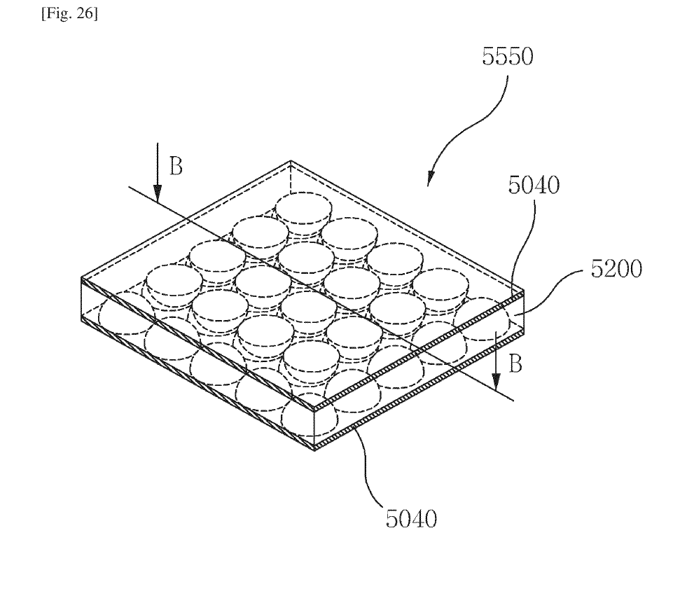

As described above, according to the fifth embodiment of the present invention, the configuration and acting effect of the insulation structure 5450 will be explained with reference to FIGS. 24 and 25 as follows;

An insulation structure 5450 comprises insulation units 5250 of a gathering state coating a heat reflective film 5120 in parts in a closed space of a hemisphere type. The insulation units 5250 are engraved into the basic material 5200 of a predetermined thickness.

The basic material 5200 is made of Synthetic resins, Rubber materials, Vinyl resins, Styrofoam, etc. that have a property of the flame-retardant.

Each of the insulation units 5250 comprises a closed space 5030 of a hemisphere type formed on the surface of the basic material 5200, a heat reflective film 5120 coated on the inner circumference of the closed space of a hemisphere type and a transparent sheet 5040 sealing the closed space 5030 of a hemisphere type on the inner circumference of which the heat reflective film is formed. It is preferable that a diameter of the insulation unit 5250 is within the range of 2 to 35 mm, but not limited to this size. The size may be properly changed according to the conditions of use.

The transparent sheet 5040 is made of Synthetic resins of transparent plastics, transparent Vinyl materials, etc. to have a thickness of 0.1 to 0.2 mm, and the heat reflective film 5120 is configured to coat an aluminum film having a thickness of 0.005 to 0.02. The closed space 5030 of a hemisphere type forming the heat reflective film 5120 on the inner circumference thereof is sealed by the transparent sheet 5040 to be isolated from the open air. The air may be filled up in the closed space of a hemisphere type at a predetermined pressure. Furthermore, the argon gas having the heat transmission coefficiency lower than that of the air may be injected and sealed into the closed space.

The insulation structure 5250 as described above makes the heat rays limitedly do the scattered-reflection by the heat reflective film 5120 in the closed space of a hemisphere type if the heat rays 5039 are incident from the outside into the inside of the insulation units 5120, so that a part of the heat rays is kept in a captured state therein and the other is radiated through the transparent sheet 5040. Therefore, the convection movement of the heat doesn't happen lively in the closed space, thereby making the temperature change gotten small and improving the insulation property.

The insulation unit 5250 makes the closed space thereof basically isolated from the polluted open air even with lapse of long time after installation. Therefore, the reflective efficiency of the heat is not deteriorated for a long time. It has an advantage in that the insulation units are supported by the basic materials 5200 to be not easily changed in a structure by external force.

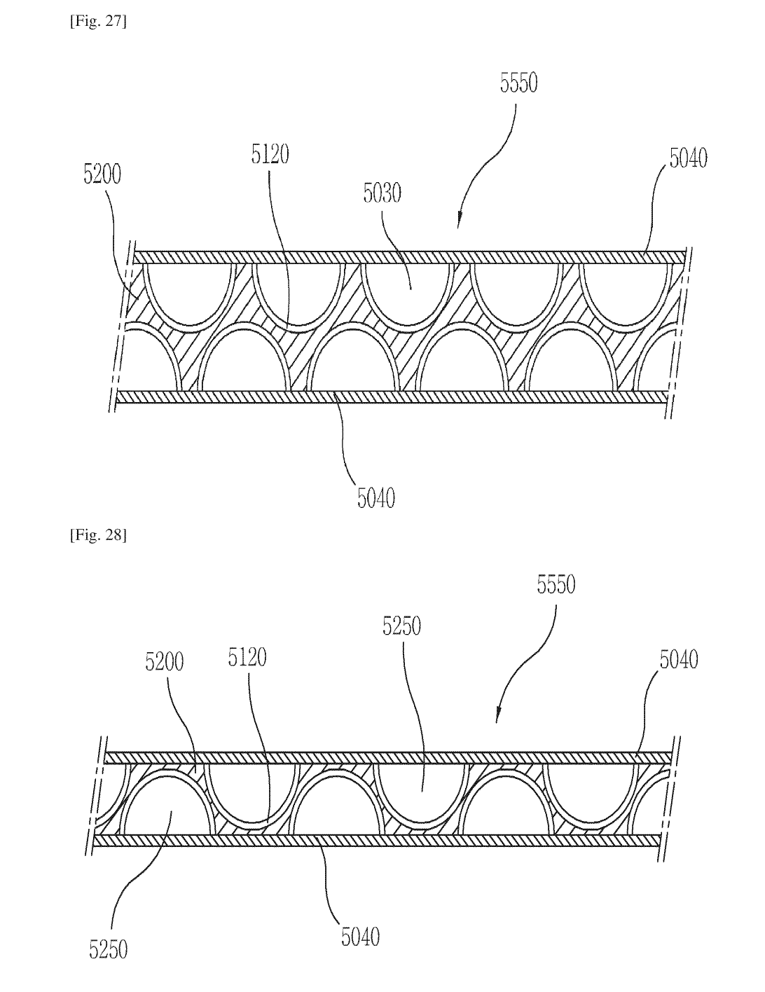

The insulation structure 5450 is no limited to the configurations of FIGS. 24 and 25, and instead may be constructed like a configuration shown in FIGS. 26 and 27. As shown in FIGS. 27 and 28, an insulation structure 5550 comprises insulation units 5250 of a hemisphere type to face each other in the basic material 5200. The insulation units 5250 is arranged to place the relatively thinner basic material 5200 there between as shown in FIG. 28 and to form the basic material 5200 thicker than the configuration as shown in FIG. 27.

### Sixth Embodiment

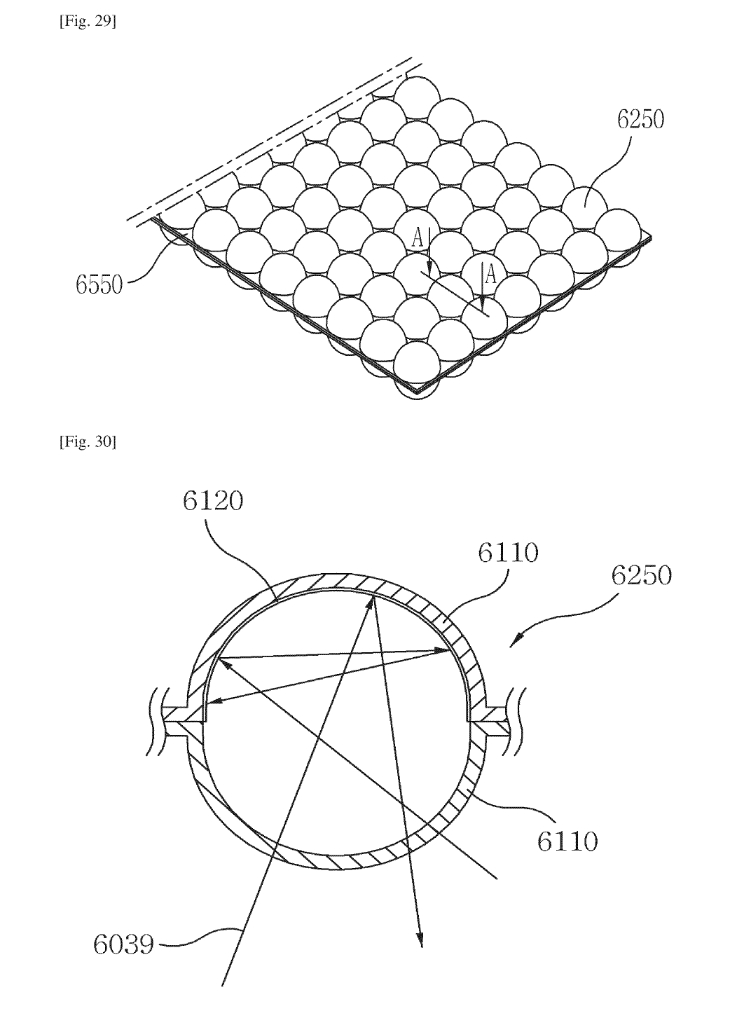

A sixth embodiment of the present invention will be explained in detail with reference to FIGS. 29 to 45.

As shown in FIGS. 29 to 30, an insulation structure 6550 comprises insulation units 6250, on a part of which a heat reflective film 6210 is coated in a closed space. The insulation units 6250 comprises coating membranes 6110, each of which is made of the same material, and a heat reflective film 6120 of a hemisphere type in a domed form, a part of which is coated in an inner space of the coating membrane. Therefore, the insulation unit includes an integral independent sphere. It is preferable that a diameter of the insulation unit is 2 to 35 mm, but not limited to the size and may be properly changed in a size according to the conditions of use.

The insulation unit 6250 of a sphere type is constructed in a manner to form a partial heat reflective film 6120 on the inner circumference of the coating membrane 6110 made of Synthetic resins including a transparent plastic, etc. and transparent Vinyl. The coating membrane 6110 has a thickness of 0.1 to 0.2 mm. The heat reflective film 6120 includes an aluminum film coated in parts by a thickness of 0.005 to 0.01 mm. The coating membrane may be made of a transparent flame retardant material or a material mixed with a transparent flame retardant one. A part of the coating membrane coated with the partial heat reflective film 6120 may not be positively made of a transparent material and instead an opaque material.

After or in the procedure that the partial heat reflective film 6120 is formed, the closed space of a sphere type is completely sealed to be isolated from the open air. The closed space is filled up with air in a predetermined pressure. Also, the closed space may be filled up with an argon gas, etc. having the heat transmission coefficiency lower than that of air.

The insulation unit 6250 makes the heat rays do the scattered reflection by the partial heat reflective film 6120, if the heat rays 6039 are incident and transmitted into the inside from the outside of the insulation unit. Therefore, a part of the incident heat rays is kept in a captured state in the closed space, and the other is mostly radiated through a portion having the partial heat reflective film. It improves the insulation property to keep warmth bordering on the insulation units 6250.

The insulation unit 6250 makes the closed space thereof basically isolated from the polluted outside air even with lapse of long time after installation. Therefore, the heat reflective efficiency in the closed space of a sphere type is not deteriorated for a long time. The insulation units 6250 each may be made of a sphere type to be independent completely, but the insulation units 6250 are preferably constructed in a gathering group of an integral manner to form an insulation structure 6550 as shown in FIG. 29 considering a manufacturing cost.

As shown in FIG. 29, a manufacturing method of an insulation structure 6550 comprises steps of preparing a plurality of upper coating membranes 6110 made of a transparent vinyl having a thickness of 0.1 m, each of which is formed in a domed shape having a recess of a hemisphere type, forming a partial heat reflective film coating an aluminum film of 0.006 mm in a domed shape in the inner circumference of the upper coating membrane 6110, preparing a plurality of lower coating membranes 6110 made of a transparent vinyl having a thickness of 0.1 m, each of which is formed in a domed shape having a recess of a hemisphere type, and joining the upper coating membrane 6110 forming the partial heat reflective film to the lower coating membrane 6110 to face their domed structures to each other and form a closed space of a sphere type.

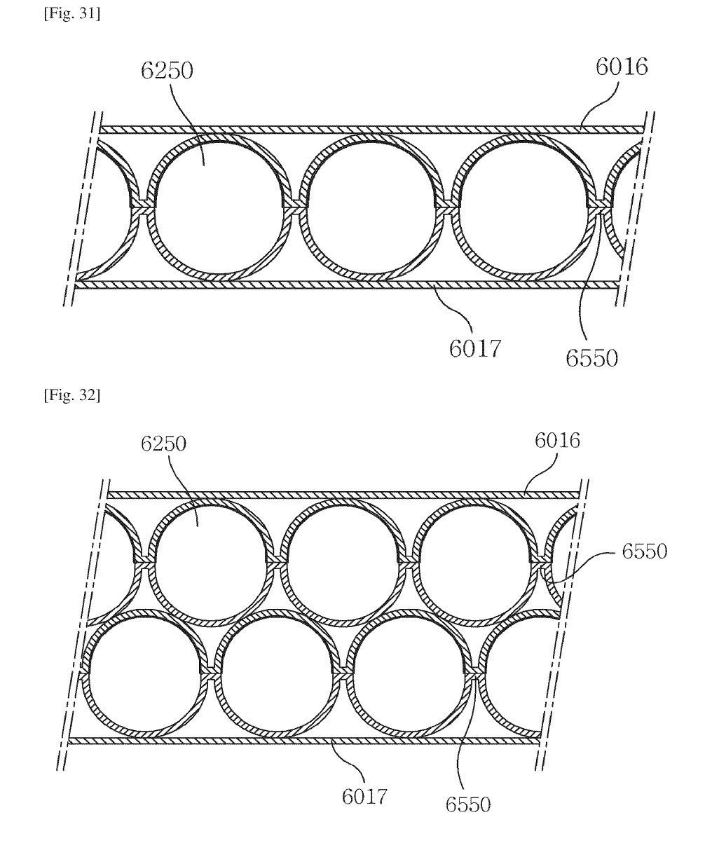

The insulation structure 6550 is formed in a single story and supported with outer shells 6016 and 6017 being wrapped as shown in FIG. 31 or stacked in multilayered stories and supported with outer shells 6016 and 6017 being wrapped as shown in FIG. 32. In FIGS. 31 and 32, the outer shells 6016 and 6017 are supported only on one side thereof and made of a plate material of Styrofoam etc., Wooden boards, Vinyl sheets, Nonwoven fabrics, Woven synthetic fibers, Cloths made of natural fibers.

According to the sixth embodiment of the present invention, the insulation structure has advantages in that the spaces between the insulation units serve as a ventilation passage with the open air, thereby improving the efficiency of the installation work, significantly. Furthermore, the insulation structure is freely bendable and foldable to be compatibly used in a space of a curved wall, etc. Further, even if a part of the insulation units is damaged, the other mostly insulation units is not taken effect on the function thereof, so that any influence on the insulation efficiency is not taken, greatly, without a separate repair.

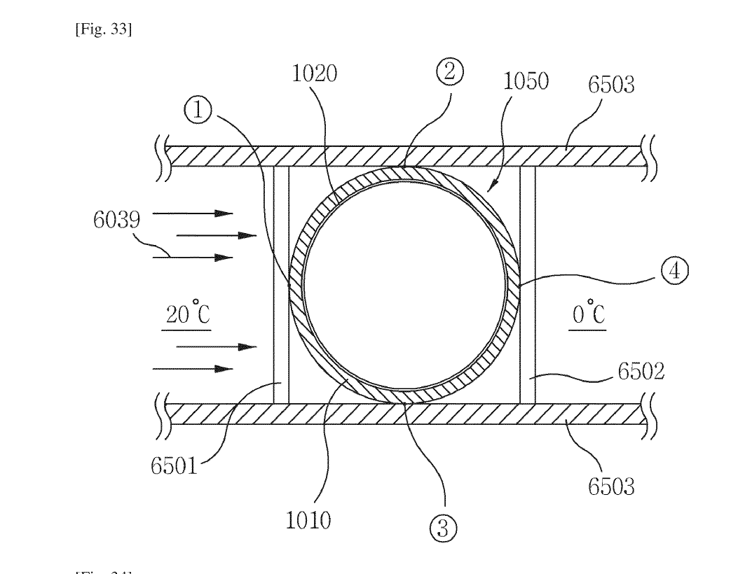

Examples of the insulation characteristics of an insulation unit in the sixth embodiment and an insulation unit in the first embodiment compared and tested will be described with reference to FIGS. 33 to 40.

First, as shown in FIG. 33, a sample of the insulation unit in the first embodiment is made and put in a test chamber.

The insulation unit 1050 are constructed so that a coating membrane 1010 made of a transparent vinyl having a thickness of 0.1 mm includes a sphere, an aluminum film is coated on the entire inner circumference of an inner space of a sphere type by a thickness of 0.006 mm to form a heat reflective film 1020. An outer diameter of the insulation unit 1050 is fixed by 30 mm.

The test chamber includes a regular hexahedron having an inner space of a volume of 30 mm×30 mm×30 mm, which comprises a first surface 6501 positioned in an incident direction of the heat rays and isolating films 6503 of four surfaces for preventing the transmission and emission of the heat rays except the second surfaces 6502 facing the first surface 6501. The first and second surfaces 6501 and 6502 includes a double board of a polyester having a thickness of 3 mm and a heat conductivity of λ=0.027 W/mk.

In one example of the first embodiment, the insulation unit 1050 between the first and second surfaces 6501 and 6502 is set in the test chamber. After the first surface 6501 and the second surface 6502 are isolated from the open air positioning on each sides of 20° C. and 0° C., the temperature changes are measured using Comsol multiphysics simulation program equipment at positions of \textcircled{1}, \textcircled{2}, \textcircled{3}, \textcircled{4} for approximately one day.

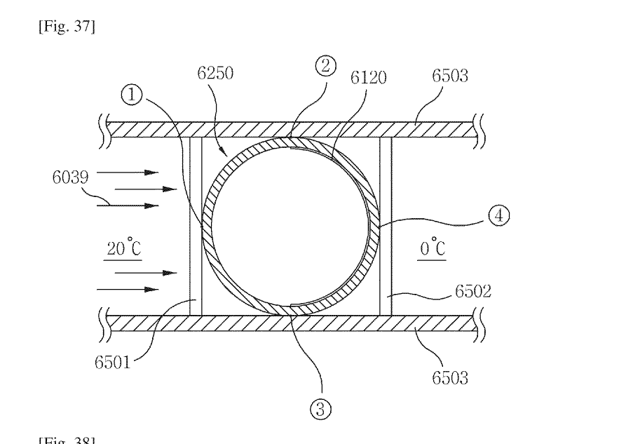

Subsequently, after the insulation unit 6250 in the sixth embodiment is manufactured in the same method, condition and size to be compared with the characteristics of one example of the first embodiment, the insulation unit 6250 is set in the test chamber under the same conditions as shown in FIG. 37 to measure the temperature changes at positions of \textcircled{1}, \textcircled{2}, \textcircled{3}, \textcircled{4} for approximately one day. Only, the insulation unit 6250 is disposed so that the partial heat reflective film 6120 is positioned on the second surface to face the first surface 6501.

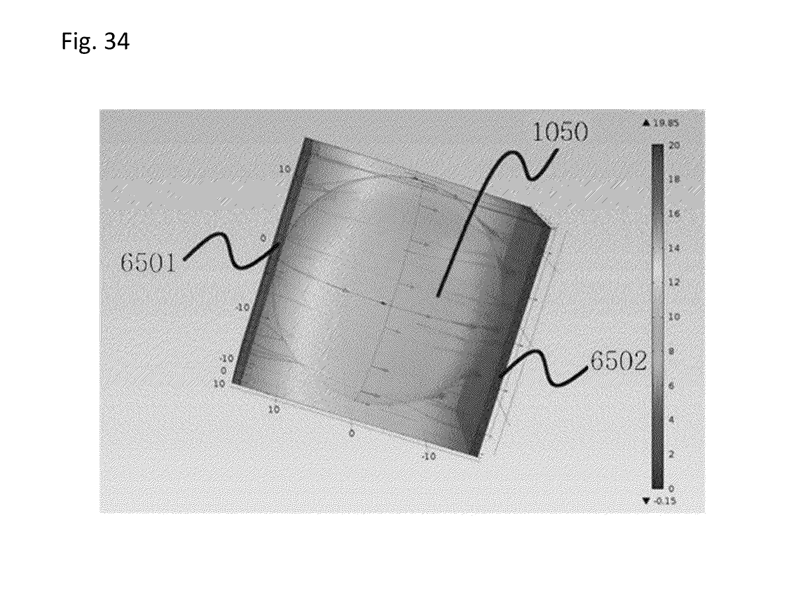

The inner spaces of a sphere type in the insulation units 1050 and 6250 according to the first and sixth embodiments are manufactured to have the same pressure at a normal temperature. A result for measuring the temperature change under the same conditions shows that as known in a simulation solid view of FIG. 34 the diffusion movement of the heat to the inner space of the insulation unit 1050 is not made, lively, for 8000 seconds (about 2 hours), and the heat emission toward the second surface 6502 by the reference of the insulation unit 1050 doesn't occur, greatly.

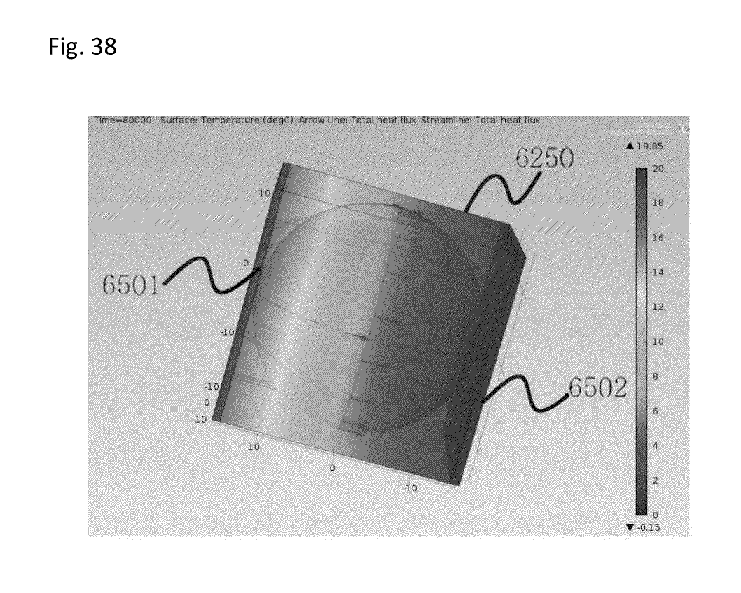

As known in a simulation solid view of FIG. 38, the insulation unit 6250 in the sixth embodiment deteriorates the heat diffusion movement in the inner space thereof for 8000 seconds (about 2 hours), significantly, compared with that of FIG. 34, and the heat emission toward the second surface by the reference of the insulation unit 6250 doesn't occur, almost.

In FIGS. 34 and 38, most deep red portions show regions nearing 20° C., and a blue portion shows a low temperature region getting into most deep blue. Namely, it is known that the insulation unit 6250 in the sixth embodiment has the insulation property superior than that of one 1050 in the first embodiment.

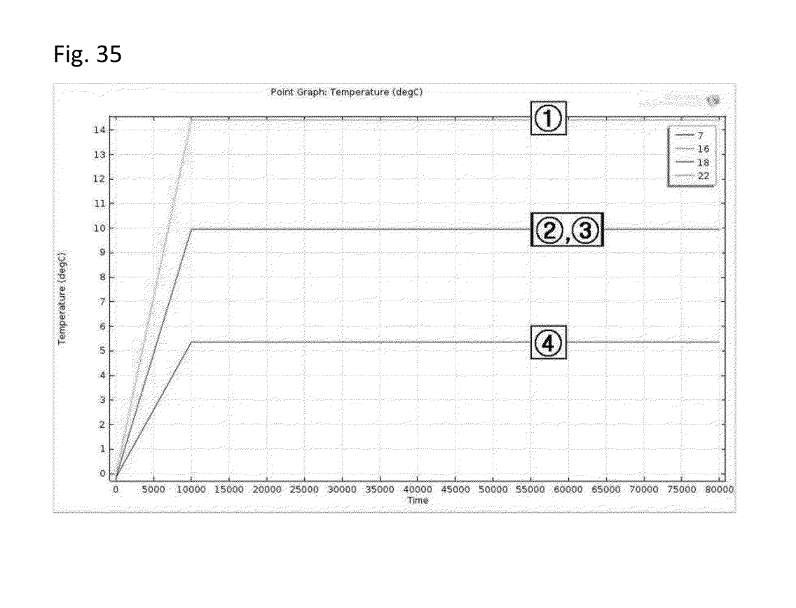

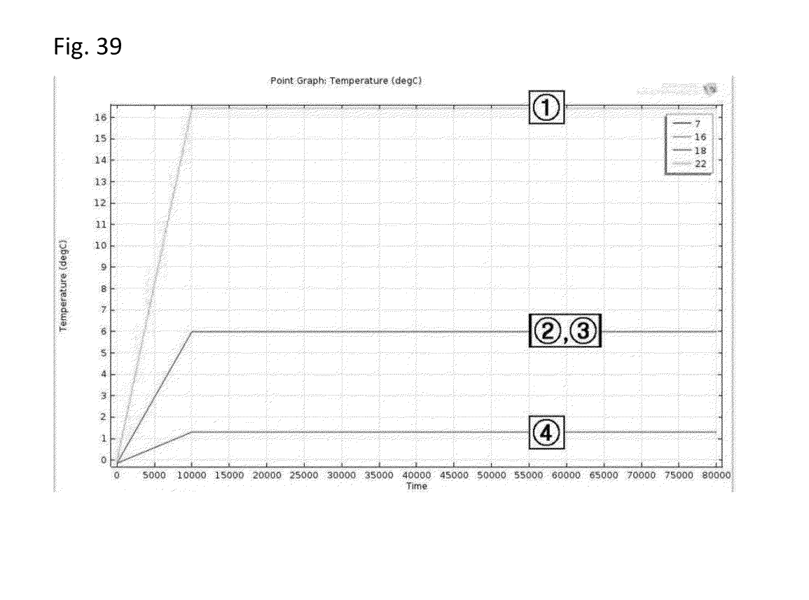

Graphs illustrating heat movements of each of the insulation units 1050 and 6250 in the first and sixth embodiments as shown in FIGS. 35 and 39 are compared with each other per every time. It is known that the insulation unit in FIG. 35 is raised at the point \textcircled{1} by about 14° C. for 3000 seconds (approximately 3 hours), and the insulation unit in FIG. 39 is raised by about 16° C. for 3000. The reason is why the heat rays reflected in the insulation unit is emitted toward the first surface 6501 through the transparent part of the coating membrane not to form the reflective film. But, it is known that the temperature changes at the points \textcircled{2}, \textcircled{3} and \textcircled{4} of the insulation unit in both grapes have remarkable differences.

At the points \textcircled{2} and \textcircled{3} of the insulation unit in both grapes the temperature is raised by 10° C. for 10,000 seconds (approximately 3 hours) in FIG. 35, and at the point \textcircled{4} the temperature is raised by 6° C. Thereafter, the temperature is kept at a constant level without being changed for 80,000 seconds (approximately one day). In FIG. 39, the temperature is raised by 7° C. for 10,000 seconds (approximately 3 hours), and at the point \textcircled{4} the temperature is raised only by 2° C. Thereafter, the temperature is kept at a constant level without being changed for approximately one day.

As shown in grapes of FIGS. 35 and 39, at the points \textcircled{2}, \textcircled{3} and \textcircled{4} of the insulation units, the maximum temperature in the grape of FIG. 39 is lower than that in the grape of FIG. 35 and the insulation units are kept at a relatively lower temperature for approximately one day.

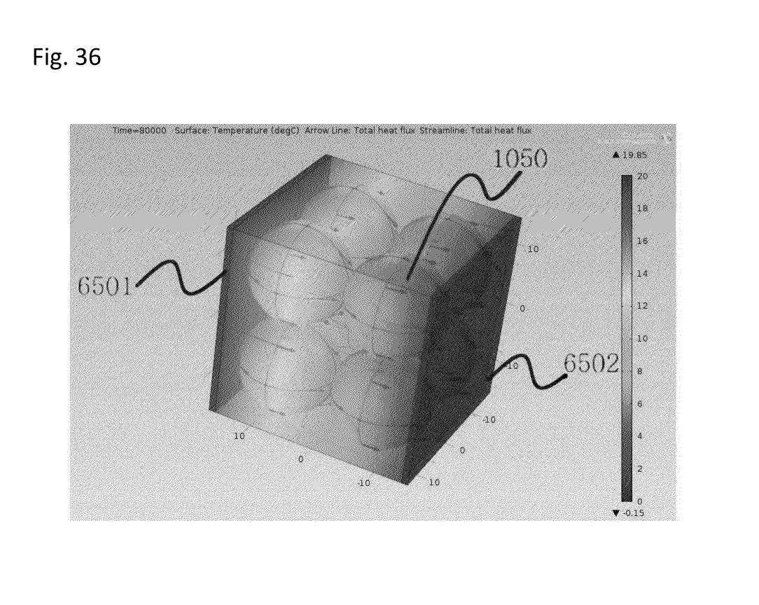

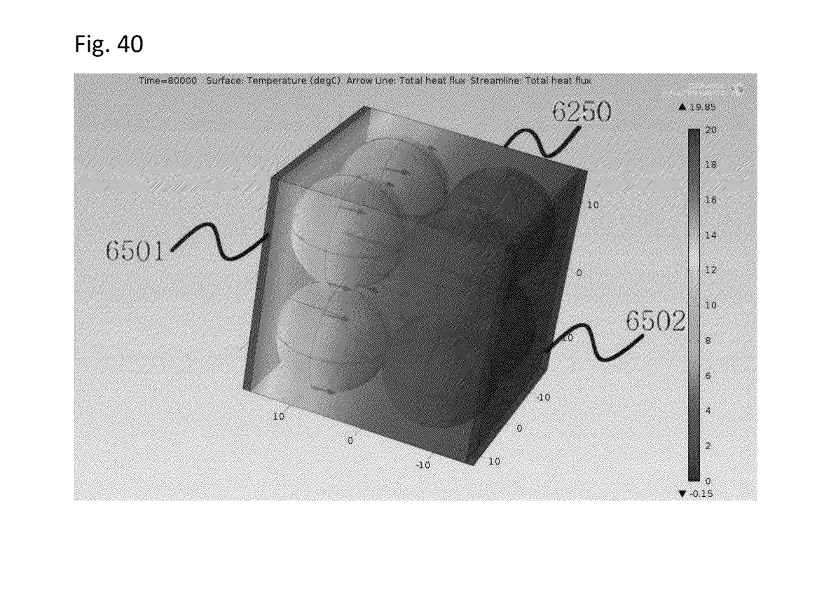

In addition to these tests, as shown in FIGS. 36 and 40, the insulation units 1050 and 6250 are disposed in each of the test chambers having a different size to measure the temperature change. It is confirmed that the measured results shows a same pattern. As known from the test results the insulation unit 6250 of the sixth embodiment forming the partial heat reflective film of a hemisphere type has the insulation property superior than that of the heat reflective film on the inner front of the first embodiment.

The reason is why the heat rays incident into the insulation unit by the partial heat reflective film in a domed shape are induced to limitedly do the scattered-reflection in the inner space of a sphere type to make a part of the heat rays at a captured state in the space of a sphere type and the other reflected and emitted toward a portion excluding the heat reflective film.

Even if a coating area of the partial heat reflective film 6120 is coated by over about 60 to 70% over the region of a hemisphere type or by about 40%, the insulation unit of the present invention derives the same result.

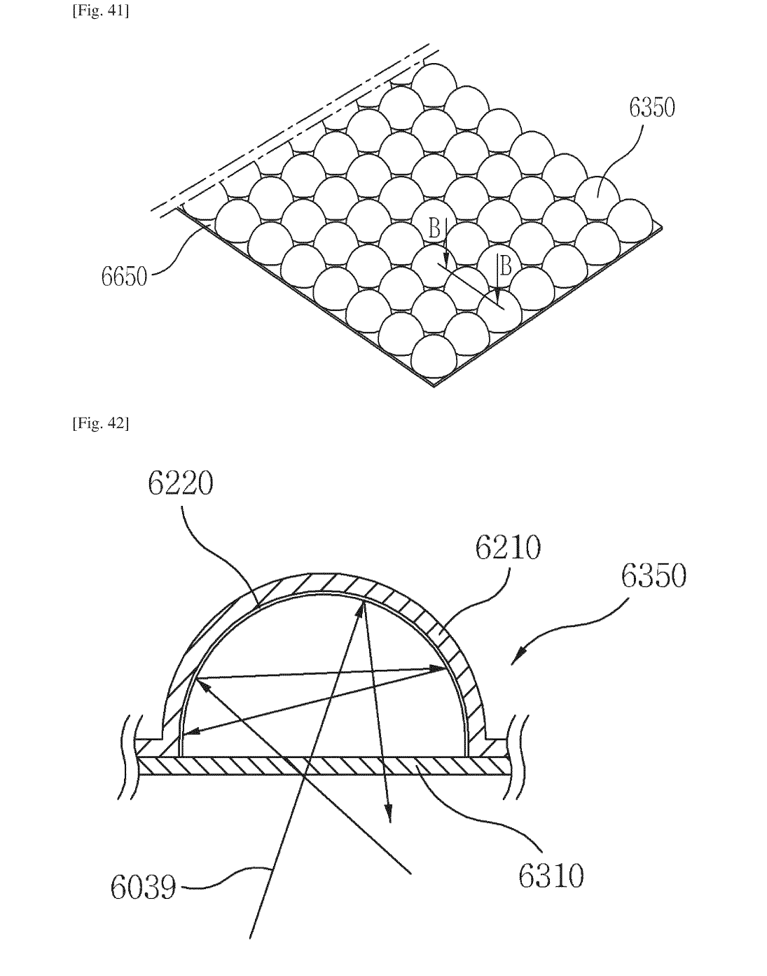

Another example in the sixth embodiment of the present invention will be described with reference to FIGS. 41 and 42 as follows;

As shown in FIGS. 41 and 42, an insulation structure 6650 comprises insulation units 6350 coating a heat reflective film 6220 in parts in a closed space.

The insulation unit 6350 comprises a coating membrane 6210 of a hemisphere type made of the same material, a partial heat reflective film 6220 formed by a method of coating an inner space of the coating membrane and a planar coating membrane 6310 made of a transparent vinyl joined to the coating membrane to isolate the coating membrane from the open air and form the closed space.

A diameter of the insulation unit 6350 of a hemisphere type is preferably 2 to 35 mm, but not limited thereto and may be properly changed and used according to the conditions of use.

The insulation unit 6350 of a hemisphere type comprises a partial heat reflective film 6220 formed on the inner circumference of the coating membrane 6210 of a hemisphere type made of Synthetic resins, for example transparent plastic, etc. and a transparent vinyl material. The coating membrane 6210 has a thickness of 0.005 to 0.01 mm, the partial reflective film 6220 is coated with an aluminum film of a thickness of 0.005 to 0.01 mm and the coating membrane is made of a known transparent fireproofing material or a material mixed with a transparent flame-retardant material. The coating membrane coating the partial heat reflective film and the planar coating membrane may be positively not necessary a transparent material, and instead an opaque material is usable.

After or in the process of forming the partial reflective film 6220, the inner space of a hemisphere type is entirely isolated from the open air. The air is filled up at a predetermined pressure in the inner space of a hemisphere type, or the argon gas having the heat transmission coefficiency lower than that of air is injected into the inner space of a hemisphere type. And then the closed space is sealed.

In the insulation1 unit 6350 as described above, if the heat rays 6039 are incident into and transmitted through the inner portion from the outside of the insulation unit, the incident heat rays are reflected in a scattered manner by the partial heat reflective film in the inner space of a hemisphere type, a part thereof is kept in a captured state and the other part thereof is transmitted through the planar coating membrane 6310 that doesn't form the heat reflective film and radiated toward the incident portion of the heat rays in the inner space. Therefore, the insulation characteristic is improved with the warmth being kept bordering on the insulation unit 6350.

The insulation unit 6350 makes its inner space thereof basically isolated from the exposure to the open air polluted even with lapse of a long time after installation, thereby preventing the deterioration of the heat reflective efficiency in the inner space of a hemisphere type, permanently.

The insulation unit 6350 may be constructed in each of independent hemisphere bodies, but as shown in FIG. 41 it is preferable to configure an insulation unit 6650 including the insulation units 6350 to be integrally gathered in groups.

As shown in FIG. 41, a manufacturing method of an insulation structure 6650 comprises steps of preparing an upper coating membrane 6210 made of a transparent vinyl having a thickness of 0.1 mm, wherein the upper coating membrane includes a plurality of domed structures provided with a recess of a hemisphere type, forming a partial heat reflective film 6220 including an aluminum having a thickness of 0.1 mm coated on the inner circumference of the recess in the upper coating membrane 6210, preparing a lower planar coating membrane 6310 made of a vinyl having a thickness of 0.1 mm, preparing an upper coating membrane 6210 including the partial heat reflective film formed in the recess and forming a closed space of a hemisphere type attaching the lower planar coating membrane 6310 to the upper coating membrane 6210 to face each other.

The other example of the sixth embodiment according to the present invention will be described with reference to FIGS. 42 to 45 as follows;

In FIGS. 42 to 45, an insulation structure 6750 comprises insulation units 6450 including a partial reflective film 6320 coated in parts on a closed space thereof. The insulation unit 6450 comprises a pyramid coating membrane 6315 each made of the same material, a partial heat reflective film 6320 formed in a manner to be coated in the inner space of the coating membrane and a planar coating membrane 6410 made of a vinyl that is joined to the pyramid coating membrane to form a closed space covering the pyramid planar coating membrane. The insulation unit 6450 may be properly changed and used in size changed according to the conditions of use.

The pyramid insulation unit 6450 includes a partial heat reflective film 6320 formed on the inner circumference of the pyramid coating membrane made of Synthetic resin such as a transparent plastic, a transparent vinyl, etc. The coating membrane 6315 has a thickness of 0.1 to 0.2 mm, the partial reflective film 6320 includes an aluminum film coated by a thickness of 0.005 to 0.01 mm and the coating membrane made of a transparent flame retardant material or a material mixed with a transparent flame retardant one. The coating membrane 6315 coating the partial heat reflective film 6320 and the planar coating membrane 6410 may be made of an opaque material, positively not made of a transparent material.

After or in the process of forming the partial reflective film 6320, the pyramid inner space is completely isolated from the open water. The air is filled up at a predetermined pressure in the pyramid inner space sealed, or the argon gas having the heat transmission coefficiency lower than air is injected into the pyramid inner space.

In the insulation1 unit 6450 as described above, if the heat rays 6039 are incident into and transmitted through the inner portion from the outside of the insulation unit, the incident heat rays are reflected in a scattered manner by the partial heat reflective film 6320 in the inner space of a pyramid type, a part thereof is kept in a captured state and the other part thereof is transmitted through the planar coating membrane 6410 that doesn't form the heat reflective film and radiated toward the incident portion of the heat rays in the inner space. Therefore, the insulation characteristic is improved with the warmth being kept bordering on the insulation unit 6450.

The insulation unit 6450 makes its inner space thereof basically isolated from the exposure to the open air polluted even with lapse of a long time after installation, thereby preventing the deterioration of the heat reflective efficiency in the inner space of a pyramid type, permanently.

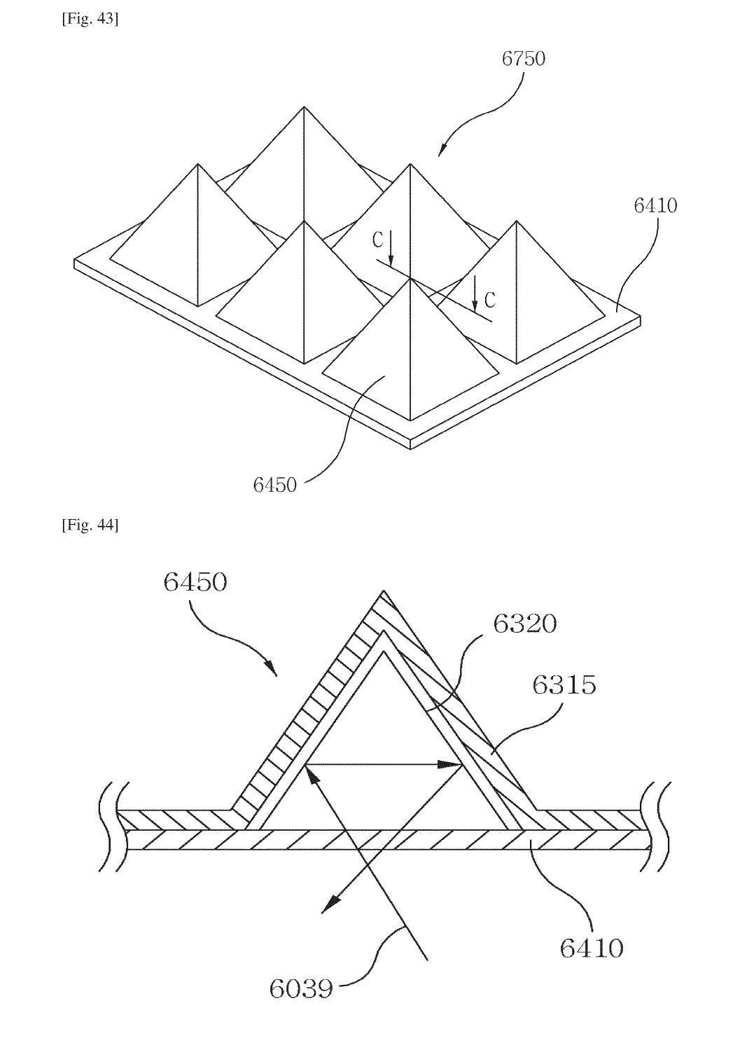

The insulation unit 6450 may be constructed in each of independent hemisphere bodies, but as shown in FIG. 43 it is preferable to configure an insulation unit 6750 including the insulation units 6450 to be integrally gathered in groups.

As shown in FIG. 43, a manufacturing method of the insulation structure 6750 comprises steps of preparing an upper coating membrane 6315 made of a transparent vinyl having a thickness of 0.1 mm, wherein the upper coating membrane includes a plurality of configurations provided with a recess of a pyramid type, forming a partial heat reflective film 6220 including an aluminum having a thickness of 0.06 mm coated on the inner circumference of the recess in the upper coating membrane 6210, preparing a lower planar coating membrane 6410 made of a vinyl having a thickness of 0.1 mm, preparing an upper coating membrane 6315 including the partial heat reflective film formed in the recess and forming a closed space of a hemisphere type attaching the lower planar coating membrane 6110 to the upper coating membrane 6315 to face each other.

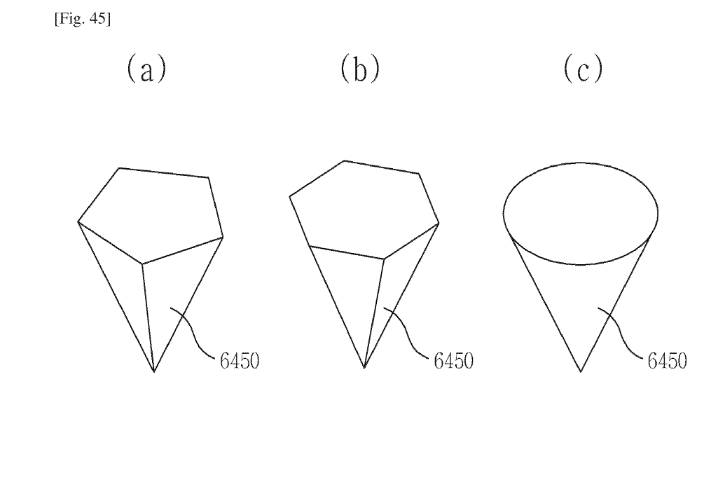

In FIG. 43, the insulation structure is not limited to the closed space of a 4-sided pyramid type, but configured in a various form of a five-sided pyramid, 5-sided pyramid and a conical shape, etc. as shown in FIG. 45. The heat rays are reflected in a scattered manner by the partial heat reflection film having a curved surface in the closed space. A part of the heat rays doing the scattered-reflection reflected in a scattered form partial heat reflection film.

In the sixth embodiment, there are omitted some drawings and explanation, but a configuration of mixing insulation units having various sizes and shapes may be made. In this case, it is preferable that patterns of the partial heat reflective films in each of insulation units are disposed in a manner to have a certain rule.

As described above, the explanation from the first embodiment to the sixed embodiment is made, but not limited thereto. The present invention can be variously changed and executed within the patent claiming scope and the objects of the invention.

### INDUSTRIAL APPLICABILITY

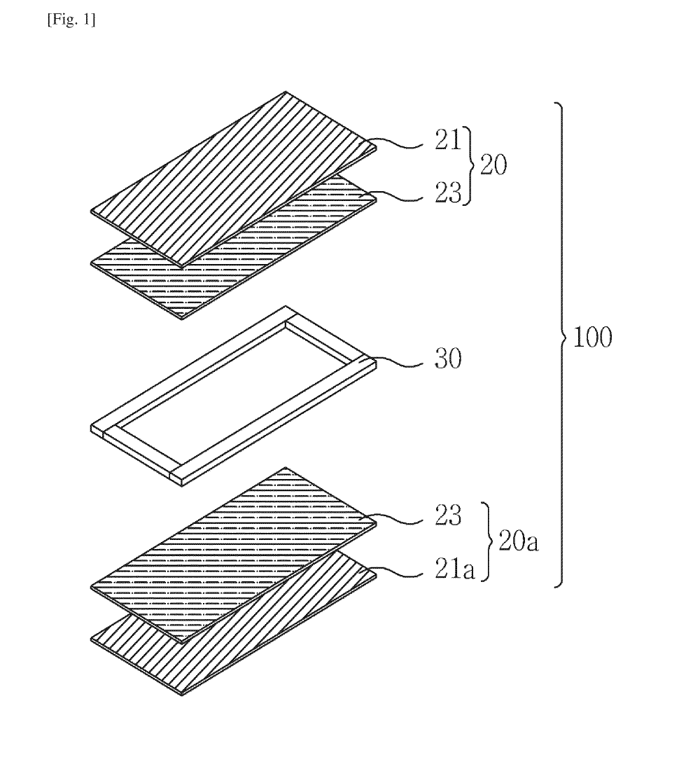

In construction fields, etc. there are done various studies for increasing the insulation efficiency. For one example, Korean Patent Laid-Open Publication No. 2011-82099 discloses that as shown in FIG. 1 a heat reflective multi-story panel 100 comprises a pair of heat reflective plates 20 and 20a disposing heat reflective materials 23 to face each other on one sides of each of surface materials 21 and 21a and a spacer 30 inserted between the heat reflective plates 20 and 20a to form an air layer.

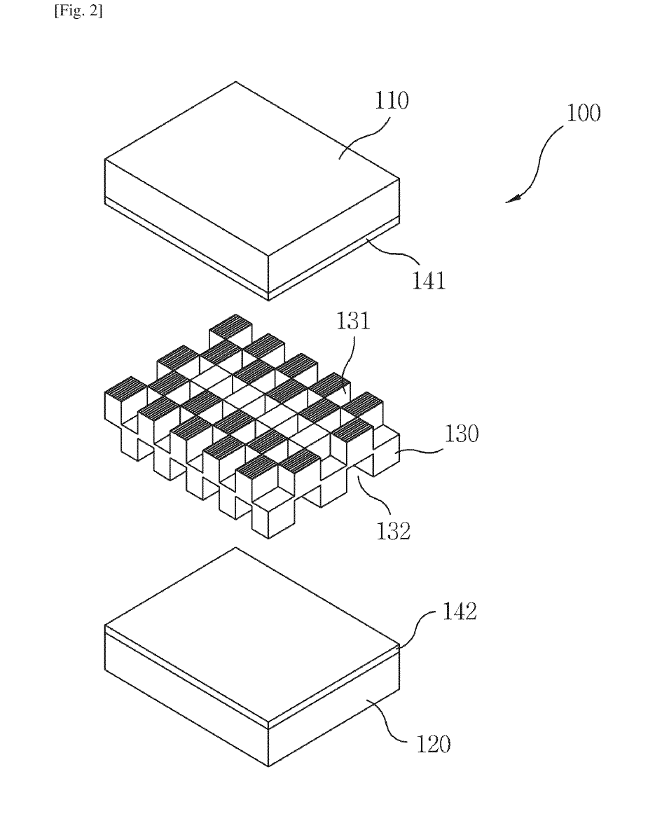

Also, as shown in FIG. 2, Korean Patent Laid-Open Publications No. 2013-19786 discloses that an insulation structure comprises a first insulation panel 110 and a second insulation panel 120 each including a first radiant heat reflective sheet 141 and a second radiant heat reflective sheet 142 disposed on each one side thereof to face each other and an intermediate panel 130 each forming grooves 131 and 132 in a certain pattern between the radiant heat reflective sheets 141 and 142.

As described above, the general insulation structures have disadvantages in that since the heat reflective plate and the radiant heat reflective sheet are easily exposed to a pollution source due to the open air, the heat reflective efficiency is decreased as time passes after installation. Due to it, the insulation durability drops.

Also, it has structural defects in that due to a larger volume and greater size the insulation structure is difficult to handle, used only for the building insulation and has limitations to the use compatible with home appliances and industrial plants such as special clothes, automobiles, refrigerators, etc. that need the insulation or keeping warmth except for the building insulation.

Considering these problems, the present invention comprises an insulation structure including a plurality of insulation units of a sphere or hemisphere type, on at least the inner circumference of which a heat reflective film is coated.

What is claimed is:

1. An insulation structure comprising:
a coating membrane including a space therein; and
a plurality of insulation units including a heat reflective film to be coated on the entire inner circumference of the space.

2. The insulation structure of claim 1, wherein:
the insulation unit is configured as a sphere or hemisphere.

3. The insulation structure of claim 1, wherein:
the insulation unit includes an integral independent entity.

4. The insulation structure of claim 1, wherein:
the heat reflective film is additionally coated on the outer circumference of the insulation unit.

5. The insulation structure of claim 1, wherein:
the space of the insulating units is closed.

6. The insulation structure of claim 5, wherein:
a gas having a heat transmission coefficient lower than air is injected into the closed space.

7. The insulation structure of claim 5, wherein:
the gas includes an argon.

8. The insulation structure of claim 2, wherein:
the heat reflective film is aluminum.

9. The insulation structure of claim 2, wherein:
the insulation unit is attached to a support member.

10. The insulation structure of claim 9, wherein:
the support member comprises one selected from the group consisting of vinyl sheets, nonwoven fabrics, synthetic fibers and natural fibers.

11. The insulation structure of claim 1, wherein:
the insulation unit is filled up in a space of a predetermined size.

12. The insulation structure of claim 2, wherein:
the insulation structure has a diameter of 2 to 30 mm.

13. An insulation structure comprising:
an insulation unit including a sphere filling the inner part thereof;
an insulation unit coating a heat reflective film on the outer circumference of the sphere; and
a mold including a space, in the inner portion of which a plurality of insulation units are filled up.

14. The insulation structure of claim 13, wherein:
the sphere is made of a foaming resin including Styrofoam and wherein the heat reflective film is made of aluminum.

15. The insulation structure of claim 13, wherein:
the mold includes the space made of at least a member selected from the group consisting of panels, vinyl sheets, non-woven fabrics, synthetic fibers and natural fibers.

16. The insulation structure of claim 13, wherein:
the insulation unit has a diameter of 10 to 100 mm.

17. An insulation structure comprising:
a first sheet including a heat reflective formed on at least one surface thereof;
a second sheet including a plurality of recesses of a hemisphere type in a domed form; and
a plurality of closed spaces formed by the recesses in a domed form between a surface forming the heat reflective film of the first sheet and the second sheet.

18. The insulation structure of claim 17, wherein:
the heat reflective films are disposed on both sides of the first sheet.

19. The insulation structure of claim 17, wherein:
the first sheet is made of at least a member selected from the group consisting of: panels, vinyl sheets, non-woven fabrics, synthetic fibers and natural fibers,
and wherein the heat reflective film includes an aluminum or silver foil.

20. The insulation structure of claim 17, wherein:
the second sheet is made of Synthetic resins or Vinyl.

21. The insulation structure of claim 17, wherein:
an argon gas having the heat transmission coefficiency lower than that of air is injected into the closed space.

22. A manufacturing method of an insulation structure comprising steps of:
forming a heat reflective film on at least one surface of a first sheet;
forming a plurality of recesses of a hemisphere type in a domed form on the second sheet; and
forming a plurality of closed spaces by the recesses in a domed form between a surface forming the heat reflective film of the first sheet and the second sheet.

23. An insulation structure comprising:
insulation units of a rod type arranged adjacent to each other including a closed space formed therein; and
a heat reflective film formed on an entire surface or a part surface of the closed space.

24. The insulation structure of claim 23, wherein:
the insulation units of a rod type and the closed space are configured into a cylindrical shape along a length direction thereof.

25. The insulation structure of claim 23, wherein:
the insulation units of a rod type and the closed space are configured into a semi-cylindrical shape along a length direction thereof.

26. The insulation structure of claim 23, wherein:
the heat reflective film of a cylindrical shape is formed as a sphere or a hemisphere in the closed space.

27. The insulation structure of claim 24, wherein:
the heat reflective film of a semi-cylindrical shape is formed as a hemisphere in the closed space.

28. The insulation structure of claim 24, wherein:
the insulation unit of a rod type is made of a material including any one of Synthetic resins, Vinyl and Styrofoam, and the heat reflective film includes an aluminum or silver foil.

29. The insulation structure of claim 24, wherein:
an argon gas having the heat transmission coefficiency lower than that of air is injected into the closed space.

30. An insulation structure comprising:
a basic material;
a plurality of closed spaces of a hemisphere type formed on at least one side of the basic material;
a heat reflective film formed in the closed space of a hemisphere type; and
a transparent sheet joined to the basic material forming the closed spaces to isolate the closed space from open air thereon,
wherein a thickness of the basic material is at least greater than a radius of the closed space.

31. The insulation structure of claim 30, wherein:
The basic material includes a fire proofing resin or a vinyl resin.

32. An insulation structure comprising:
a basic material, a plurality of closed spaces of a hemisphere type formed on at least both sides of the basic material; a heat reflective film formed in the closed space of a hemisphere; and
a transparent sheet joined to both sides of the basic material forming the closed spaces to isolate the closed space from the open air thereon.

33. The insulation structure of claim 32, wherein:
the basic material is made of a flame retardant resin or a vinyl resin.

34. An insulation structure comprising:
a coating membrane forming a closed space; and
a plurality of insulation units including a heat reflective film formed in parts on a curved surface of the inner circumference of the coating membrane to reflect heat rays incident into the closed space toward the outside of the coating membrane.

35. The insulation structure of claim 34, wherein:
the heat reflective film is in the form of any one to be selected among a hemisphere shape, a pyramid shape and a conical shape, and the partial coating membrane includes at least one part that is transparent.

36. The insulation structure of claim 34, wherein:
the partial heat reflective film is disposed in a direction having a certain rule.

37. The insulation structure of claim 34, wherein:
the insulation structure further comprises a shell additionally formed on at least one side thereof.

38. A manufacturing method of an insulation structure comprising steps of:
preparing a first sheet in the inner circumference of which a plurality of recesses are formed;
forming the heat reflective film inside the recesses;
preparing a second sheet on a side opposite to the recesses of the first sheet; and
joining the first sheet to the second sheet so that the recesses of the first sheet are formed in the closed space.

39. The manufacturing method of an insulation structure of claim 38, wherein:
the recess of the first sheet is in the form of any a member selected from the group consisting of a hemisphere, a pyramid shape and a conical shape.

40. The manufacturing method of an insulation structure of claim 38, wherein:
the first and second sheets are made of a vinyl, and the partial heat reflective film made of an aluminum one.
